(19) United States
(12) Patent Application Publication
(10) Pub. No.: US 2023/0297920 A1
(43) Pub. Date: Sep. 21, 2023

(54) Quantifying Pollutant Emission Related to Downhole Conveyance Operations

(71) Applicant: Impact Selector International, LLC, Heath, TX (US)

(72) Inventor: Christopher J. Morgan, Spring, TX (US)

(73) Assignee: Impact Selector International, LLC, Heath, TX (US)

(21) Appl. No.: 18/184,514

(22) Filed: Mar. 15, 2023

Related U.S. Application Data
(60) Provisional application No. 63/269,454, filed on Mar. 16, 2022.

(51) Int. Cl. G06Q 10/0637; E21B 47/00

(52) U.S. Cl. CPC G06Q 10/06375; E21B 47/00; E21B 2200/20

(57) ABSTRACT

A processing system operable to quantify pollutant emission related to downhole conveyance operations. The processing system may comprise a processor and a memory storing computer program code that, when executed by the processor, causes the processing system to predict outputs based on inputs. The inputs may comprise conveyance equipment input data indicative of conveyance equipment operable to perform conveyance operations of a tool string within a well, and pollutant emission input data indicative of a quantity of pollutant emission related to the conveyance equipment. The outputs may comprise pollutant emission output data indicative of a quantity of pollutant emission related to the conveyance operations.

### CROSS-REFERENCE TO RELATED APPLICATIONS

This application claims priority to and the benefit of U.S. Provisional Patent Application No. 63/269,454, entitled “QUANTIFYING POLLUTANT EMISSION RELATED TO DOWNHOLE CONVEYANCE OPERATIONS,” filed Mar. 16, 2022, the entire disclosure of which is hereby incorporated herein by reference.

### BACKGROUND OF THE DISCLOSURE

Drilling operations have become increasingly expensive as the need to drill deeper, in harsher environments, and through more difficult materials has become a reality. In addition, testing and evaluation of completed and partially finished wellbores have become commonplace, such as to increase well production and return on investment. A tool string comprising one or more downhole tools may be deployed within the wellbore to perform such downhole operations. The tool string may be conveyed along the wellbore by applying controlled tension to the tool string from a wellsite surface via a conveyance line or other conveyance means.

Oil and gas reservoirs have conventionally been accessed by vertical or near-vertical wellbores. Such reservoirs, however, are increasingly accessed via non-vertical wellbores. Tool strings that have conventionally been used in the vertical or near-vertical wellbores may encounter problems when used in the non-vertical wellbores. Such tool strings may be lowered into wellbores utilizing gravity to facilitate transport or movement therethrough. In non-vertical wellbores, gravity may be negated by frictional forces between the tool string and a sidewall of the wellbore, thus resisting movement of the tool string through the wellbore. Furthermore, particularly with open-hole wellbores not lined with casing, outer surfaces of the tool string may stick to the sidewall of the wellbore. Consequently, in working with deeper, non-vertical, and more complex wellbores, it becomes more likely that tools, tool strings, and/or other downhole equipment may become stuck within the wellbore. Downhole conveyance tools, such as roller tools, tractors, and other tools, may be installed within or along a tool string to facilitate movement of the tool string along non-vertical portions of the wellbore.

However, when a tool string becomes stuck within a wellbore, a downhole jarring tool may be used to dislodge the tool string. A jarring tool may be included as part of a tool string and deployed downhole along with the downhole equipment, or a jarring tool may be deployed downhole as part of corrective operations to free a tool string after the tool string becomes stuck. Tension may be applied to the deployed tool string via a conveyance means, such as a cable or coiled tubing, to trigger the jarring tool and, thus, deliver an impact intended to dislodge the stuck tool string.

An upper end of the tool string may be or comprise a cable head operable to mechanically and/or electrically connect the conveyance means to the tool string. A cable head may also facilitate separation of the conveyance means from the tool string. For example, when a tool string becomes stuck within a wellbore, tension may be applied to a conveyance cable to break armor wires of the conveyance cable at the cable head. The conveyance cable may then be removed to the wellsite surface and corrective equipment, such as fishing equipment, may be conveyed downhole to perform corrective operations, including coupling with and retrieving the stuck tool string to the wellsite surface.

Predicting what tension to apply to the conveyance means by surface equipment and/or which downhole conveyance tools to use to facilitate planned conveyance operations, separate the conveyance means, and/or perform corrective operations is difficult due to many factors. When a tool string becomes stuck downhole, predicting what the actual magnitude and other parameters associated with the impact realized at a downhole location is also difficult. Although tension applied to the conveyance means at the surface of the wellbore may be within intended or predetermined ranges, tension experienced at the tool string and the actual impacts delivered downhole by the jarring tool to the stuck tool string may be less than intended or otherwise not as expected. Factors such as depth of the jarring tool, elastic properties and weight of the conveyance means and the tool string (including the jarring tool and the stuck tool string), wellbore deviation, and friction forces caused by contact with sides of the wellbore and/or obstructions within the wellbore, may affect success of downhole conveyance operations and/or the actual impact delivered to the tool string.

Downhole conveyance operations within oil and gas wells, including related operations that enable or otherwise facilitate such downhole conveyance operations, can create various environmental management challenges. For example, downhole conveyance operations, downhole corrective operations to remedy failed downhole conveyance operations, surface operations of various surface equipment to facilitate downhole operations, and transportation operations to transport various equipment and personnel can emit (or produce) or cause emission of various airborne pollutants (e.g., gases and particulate material) into the ambient airspace. Such pollutant emission is caused, at least in part, by combustion of fossil fuels, and can include carbon monoxide (CO), carbon dioxide (CO₂), sulfur dioxide (SO₂), nitrogen dioxide (NO₂), nitrous oxide (N₂O), ammonia (NH₃), various hydrocarbons (such as acetylene (C₂H₂), ethylene (C₂H₄), propylene (C₃H₆), and methane (CH₄)), and particulate material (e.g., carbon soot). Pollutant emission caused by the combustion of fossil fuels can include greenhouse gases (GHGs), such as CO₂, CH₄, and N₂O, which absorb and re-emit heat in the atmosphere. Because the release of GHGs into the atmosphere exacerbates the greenhouse effect (i.e., global warming), environmental protection agencies scrutinize the emission of GHGs and oftentimes require periodic reporting of quantities of HGHs emitted into the atmosphere.

Methodologies for quantifying pollutant emission that are currently available are capable of determining quantities of pollutant emission at a wellsite during oil and gas operations, such as may be based on air samples collected at the wellsite. However, current methodologies are not capable of predicting (or determining) before oil and gas operations, such as during a planning stage of oil and gas operations, a quantity of pollutant emission that is expected to be generated at the wellsite during the oil and gas operations. Such methodologies are also not capable of predicting a quantity of pollutant emission that is expected to be generated at other locations during related operations that facilitate the oil and gas operations. Accordingly, human personnel (e.g., oil and gas engineers, planners, etc.) are not able to select equipment for performing and otherwise facilitating oil and gas operations based on a quantity of pollutant emission that such equipment will release or caused to be released. Human personnel are therefore not able to preemptively control the quantity of pollutant emission that will be generated during planned oil and gas operations and related operations.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a sectional view of an example implementation of a portion of the apparatus shown in FIG. 1 according to one or more aspects of the present disclosure.

FIG. 3 is a sectional view of a portion of the apparatus shown in FIG. 2.

FIG. 4 is a bottom view of the apparatus shown in FIG. 3.

FIG. 5 is a flow-chart diagram of at least a portion of an example implementation of a method according to one or more aspects of the present disclosure.

FIG. 6 is a schematic view of at least a portion of an example implementation of a conveyance analysis engine according to one or more aspects of the present disclosure.

FIG. 7 is a flow-chart diagram of at least a portion of an example implementation of a method according to one or more aspects of the present disclosure.

FIG. 8 is a schematic view of at least a portion of an example implementation of apparatus according to one or more aspects of the present disclosure.

FIGS. 9-12 are views of an example user interface according to one or more aspects of the present disclosure.

FIG. 13 is a schematic view of at least a portion of an example implementation of a conveyance analysis engine according to one or more aspects of the present disclosure.

FIG. 14 is a table containing data received by the conveyance analysis engine shown in FIG. 13.

FIG. 15 is a table containing data output by the conveyance analysis engine shown in FIG. 13.

FIG. 16 is a display screen showing data output by the conveyance analysis engine shown in FIG. 13.

FIG. 17 is a flow-chart diagram of at least a portion of an example implementation of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

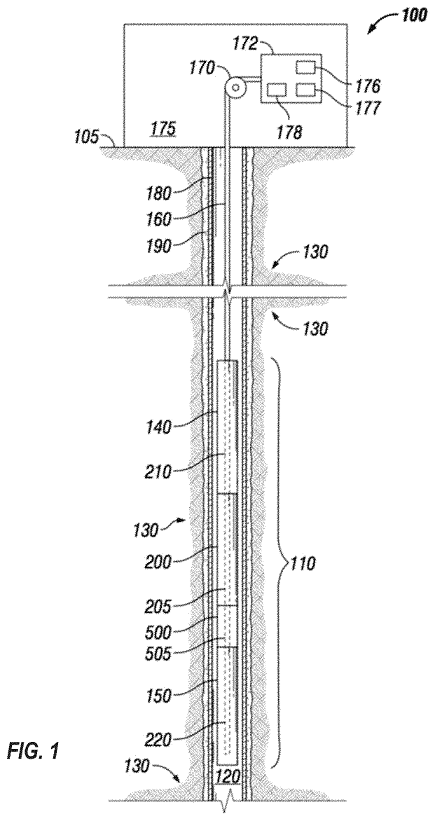

FIG. 1 is a schematic view of at least a portion of a wellsite system 100 according to one or more aspects of the present disclosure. The wellsite system 100 may comprise a tool string 110 suspended within a wellbore 120 that extends from a wellsite surface 105 into one or more subterranean formations 130. The wellbore 120 is depicted as being a cased-hole implementation comprising a casing 180 secured by cement 190. However, one or more aspects of the present disclosure are also applicable to and/or readily adaptable for utilizing in open-hole implementations lacking the casing 180 and cement 190. The tool string 110 may be suspended within the wellbore 120 via conveyance means 160 operably coupled with a tensioning device 170 and/or other surface equipment 175 disposed at the wellsite surface 105, including a power and control system 172. The tool string 110 may comprise a first portion 140, a second portion 150, and a jarring tool 200 coupled between the first portion 140 and the second portion 150. The tool string 110 may further comprise a sensor tool 500 coupled between the jarring tool 200 and the second portion 150. However, as described below, the sensor tool 500 may be coupled at other location within the tool string 110, such as between the jarring tool 200 and the first portion 140.

The jarring tool 200 and the sensor tool 500 are each implemented as single downhole tools. In the context of the present disclosure, a “single downhole tool” may be that which includes no more than two interfaces that are capable of being operably coupled or “made-up” with other downhole tools to form the tool string 110. Thus, coupling the jarring tool 200 with the sensor tool 500 does not result in a “single downhole tool” because such assembly would have four interfaces that are capable of being coupled with other downhole tools to form the tool string 110—namely, the two interfaces of the jarring tool 200 and the two interfaces of the sensor tool 500. Accordingly, assembling the jarring tool 200 with the sensor tool 500 results in two downhole tools instead of a “single downhole tool.”

The tensioning device 170 is operable to apply an adjustable tensile force to the tool string 110 via the conveyance means 160. The tensioning device 170 may be, comprise, or form at least a portion of a crane, winch, drawworks, top drive, and/or other lifting device coupled to the tool string 110 by the conveyance means 160. The conveyance means 160 may be or comprise a wireline, slickline, e-line, coiled tubing, drill pipe, production tubing, and/or other conveyance means, and may comprise and/or be operable in conjunction with means for communication between the tool string 110, the tensioning device 170, and/or one or more other portions of the surface equipment 175, including the power and control system 172. The conveyance means 160 may comprise a multi-conductor wireline and/or other electrical conductor(s) extending between the tool string 110 and the surface equipment 175. The power and control system 172 may include a source of electrical power 176, a memory device 177, and a controller 178 operable to receive and process electrical signals from the tool string 110 and/or commands from a surface operator.

The first and second portions 140, 150 of the tool string 110 may each be or comprise one or more downhole tools, modules, and/or other apparatus operable in wireline, while-drilling, coiled tubing, completion, production, and/or other implementations. The first portion 140 of the tool string 110 may comprise at least one electrical conductor 145 in electrical communication with at least one component of the surface equipment 175. The second portion 150 of the tool string 110 may also comprise at least one electrical conductor 155 in electrical communication with at least one component of the surface equipment 175, wherein the at least one electrical conductor 145 and the at least one electrical conductor 155 may be in electrical communication via at least one or more electrical conductors 205, 505 of the jarring tool 200 and the sensor tool 500, respectively. Thus, the electrical conductors 145, 155, 205, 505 may connect with and/or form a portion of the conveyance means 160, and may include various electrical connectors and/or interfaces along such path, including as described below.

Each of the electrical conductors 145, 155, 205, 505 and/or others may comprise a plurality of individual conductors, such as may facilitate electrical communication of the first portion 140 of the tool string 110, the jarring tool 200, the sensor tool 500, and the second portion 150 of the tool string 110 with at least one component of the surface equipment 175, such as the power and control system 172. For example, the conveyance means 160 and the electrical conductors 145, 155, 205, 505 may be operable to transmit and/or receive electrical power, data, and/or control signals between the power and control system 172 and one or more of the first portion 140, the jarring tool 200, the sensor tool 500, and the second portion 150. The electrical conductors 145, 155, 205, 505 may further facilitate electrical communication between two or more of the first portion 140, the jarring tool 200, the sensor tool 500, and the second portion 150.

The jarring tool 200 is operable to dislodge a portion of the tool string 110 that has become lodged or stuck within the wellbore 120, such as the second portion 150. Thus, the jarring tool 200 and the sensor tool 500 are coupled into the tool string 110 before the tool string 110 is conveyed into the wellbore.

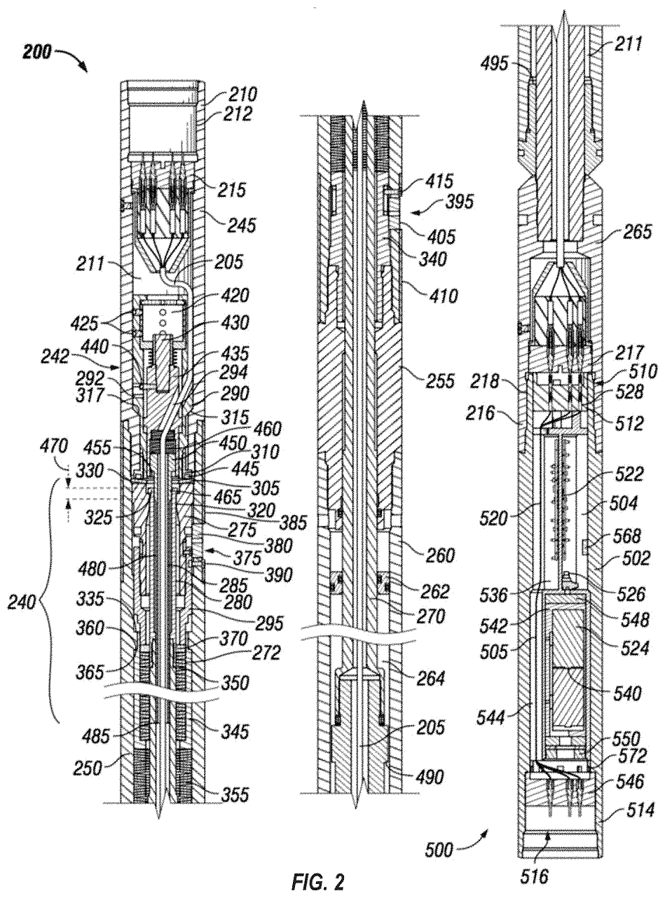

FIG. 2 is a sectional view of an example implementation of the jarring tool 200 and the sensor tool 500 shown in FIG. 1 according to one or more aspects of the present disclosure. Referring to FIGS. 1 and 2, collectively, the jarring tool 200 comprises the electrical conductor 205 in electrical communication with the electrical conductor 145 of the first portion 140 of the tool string 110 and in electrical communication with the electrical conductor 505 of the sensor tool 500. The electrical conductor 505 of the sensor tool 500 is in electrical communication with the electrical conductor 155 of the second portion 150 of the tool string 110.

For example, the jarring tool 200 may comprise one or more uphole (hereinafter “upper”) electrical connectors 215 and one or more downhole (hereinafter “lower”) electrical connectors 217 in electrical communication with the electrical conductor 205 extending therebetween. The upper electrical connector 215 may electrically connect with a corresponding lower electrical connector (not shown) of the first portion 140 of the tool string 110, wherein the lower electrical connector of the first portion 140 may be in electrical connection with the electrical conductor 145. The sensor tool 500 may comprise an upper interface 510 at an upper end of the sensor tool 500 and a lower interface 516 at an opposing lower end of the sensor tool 500. The upper interface 510 may comprise an upper electrical connector 528 and upper mechanical fastening means 512, and the lower interface 516 may comprise a lower electrical connector 546 and lower mechanical fastening means 514. The upper electrical connector 528 and the lower electrical connector 546 may be in electrical connection via the electrical conductor 505 extending therebetween. The lower electrical connector 217 of the jarring tool 200 may electrically connect with the upper electrical connector 528, and the lower electrical connector 546 may electrically connect with a corresponding upper electrical connector (not shown) of the second portion 150, wherein the upper electrical connector of the second portion 150 is in electrical connection with the electrical conductor 155. Accordingly, the electrical conductor 145 of the first portion 140 of the tool string 110 may be in electrical communication with the electrical conductor 155 of the second portion 150 of the tool string 110 via the electrical conductor 205 of the jarring tool 200, the electrical conductor 505 of the sensor tool 500, and one or more electrical connectors 215, 217, 528, 546. Consequently, the electrical conductor 145 of the first portion 140 of the tool string 110, the electrical conductor 205 of the jarring tool 200, the electrical conductor 505 of the sensor tool 500, and the electrical conductor 155 of the second portion 150 of the tool string 110, including via one or more additional electrical connectors 215, 217, 528, 546, may be in electrical communication with the surface equipment 175, such as via the conveyance means 160.

The jarring tool 200 and/or associated apparatus may be operable to detect an electrical characteristic of the electrical conductor 205, impart a first impact force on the second portion 150 of the tool string 110 when the electrical characteristic is detected, and impart a second impact force on the second portion 150 of the tool string 110 when the electrical characteristic is not detected. The second impact force may be substantially greater than or otherwise different from the first impact force. For example, the first impact force may be about 3,500 pounds (or about 15.6 kilonewtons), whereas the second impact force may be about 9,000 pounds (or about 40.0 kilonewtons). However, other quantities are also within the scope of the present disclosure. For example, the first impact force may range between about 1,000 pounds (or about 4.4 kilonewtons) and about 6,000 pounds (or about 26.7 kilonewtons), and the second impact force may range between about 6,000 pounds (or about 26.7 kilonewtons) and about 12,000 pounds (or about 53.4 kilonewtons). A difference between the first and second impact forces may range between about 1,000 pounds (or about 4.4 kilonewtons) and about 6,000 pounds (or about 26.7 kilonewtons), although other differences are also within the scope of the present disclosure.

The electrical characteristic detected by the jarring tool 200 may be a substantially non-zero voltage and/or current, such as in implementations in which the electrical characteristic is a voltage substantially greater than about 0.01 volts and/or a current substantially greater than about 0.001 amperes. For example, the electrical characteristic may be a voltage substantially greater than about 0.1 volts and/or a current substantially greater than about 0.01 amperes. However, other values are also within the scope of the present disclosure.

As at least partially shown in FIG. 2, the jarring tool 200 may further comprise an upper housing 242, which may include a first upper housing portion 245, a second upper housing portion 250 coupled to the first upper housing portion 245, a connector 255 coupled to the second upper housing portion 250 opposite the first upper housing portion 245, and a third upper housing portion 260 coupled to the connector 255 opposite the second upper housing portion 250. The several portions of the upper housing 242 comprise a central bore 211 extending therethrough, such as may be operable to contain therein the upper electrical connector 215 and other components, as described below.

The jarring tool 200 may further comprise a lower housing 265 coupled to the sensor tool 500, and a shaft 270 extending between the lower housing 265 and the upper housing 242. The shaft 270 may be fixedly coupled with the lower housing 265 and slidably coupled with the upper housing 242, wherein the shaft 270 and the upper housing 242 move axially relative to each other. The shaft 270 extends into the third upper housing portion 260, the connector 255, and the second upper housing portion 250, and terminates at a latching mechanism 240. An upper end 210 of the upper housing 242 includes an interface comprising upper mechanical fastening means 212 for coupling with a corresponding interface of the first portion 140 of the tool string 110. A lower end 216 of the lower housing 265 includes an interface comprising lower mechanical fastening means 218 for coupling with an interface comprising upper mechanical fastening means 512 of a housing 502 of the sensor tool 500. The upper and lower mechanical fastening means 212, 218 may comprise internal or external threads, one or more fasteners, box-pin couplings, other oil field component field joints and/or coupling means, and/or other means known in the art.

The latching mechanism 240 may comprise a female latch portion 275, a male latch portion 280, and an anti-release member 285. The female latch portion 275 may be slidably retained within the second upper housing portion 250 between a detector housing 290 and at least a portion of an upper adjuster 295. A floating separator 305 may be disposed between the female latch portion 275 and the detector housing 290. In the depicted implementation, the separator 305 is a Belleville washer retained between the female latch portion 275 and a lock ring 310. The lock ring 310 may be threadedly engaged with the detector housing 290 to retain mating engagement between corresponding conical or otherwise tapered mating surfaces 315 external to the detector housing 290 with corresponding conical or otherwise tapered mating surfaces 317 internal to the first upper housing portion 245, thus positionally fixing the detector housing 290 relative to the first upper housing portion 245.

The male latch portion 280 comprises a plurality of flexible members 320 collectively operable to detachably engage the female latch portion 275. While only two instances are visible in the figures, a person having ordinary skill in the art will readily recognize that more than two instances of the flexible member 320 collectively encircle the anti-release member 285. The male latch portion 280 is coupled to or otherwise carried with the shaft 270, such as via threaded means, fasteners, pins, press/interference fit, and/or other coupling 272. Thus, the female latch portion 275 is carried with and/or by the upper housing 242 and, thus, the first or upper portion 140 of the tool string 110, whereas the male latch portion 280 is carried with and/or by the lower housing 265 and, thus, the sensor tool 500 and the second or lower portion 150 of the tool string 110. The detachable engagement between the female and male latch portions 275, 280 is between an internal profile 325 of the female latch portion 275 and an external profile 330 of each of the plurality of flexible members 320.

The anti-release member 285 is moveable within the male latch portion 280 between a first position, defining a first configuration of latching mechanism 240, shown in FIG. 2, corresponding to when the jarring tool 200 detects the electrical characteristic on the electrical conductor 205, and a second position (not shown), defining a second configuration of the latching mechanism 240, wherein the external profile 330 is disengaged from and disposed below the internal profile 325, corresponding to when the jarring tool 200 does not detect (or detects the absence of) the electrical characteristic on the electrical conductor 205. The anti-release member 285 prevents radially inward deflection of the plurality of flexible members 320 and, thus, disengagement of the female and male latch portions 275, 280 when the tensile force applied across the latching mechanism 240 is substantially less than the first impact force when the anti-release member 285 is in the first position, and substantially less than the second impact force when the anti-release member 285 is moved downward to the second position. Such operation is described in greater detail below.

The upper adjuster 295 is threadedly engaged with the female latch portion 275, such that the upper adjuster 295 and the female latch portion 275 float axially between, for example, the lock ring 310 and an internal shoulder 335 of the second upper housing portion 250, and such that rotation of the female latch portion 275 relative to the upper adjuster 295 adjusts the relative axial positions of the female latch portion 275 and the upper adjuster 295. The jarring tool 200 also comprises a lower adjuster 340 disposed within the second upper housing portion 250 and threadedly engaged with the connector 255, such that the axial position of the lower adjuster 340 is adjustable in response to rotation of the lower adjuster 340 relative to the connector 255 and/or the second upper housing portion 250. The jarring tool 200 also comprises a carrier 345 slidably retained within the second upper housing portion 250, an upper spring stack 350 slidably disposed within the annulus defined within the carrier 345 by the shaft 270 and/or the male latch portion 280, and a lower spring stack 355 slidably retained between the carrier 345 and the lower adjuster 340. The upper and lower spring stacks 350, 355 may each comprise one or more Belleville washers, wave springs, compression springs, and/or other biasing members operable to resist contraction in an axial direction.

The lower spring stack 355 biases the carrier 345 away from the lower adjuster 340 in an upper direction, ultimately urging an upper-facing shoulder 360 of the carrier 345 toward contact with a corresponding, downhole-facing, interior shoulder 365 of the second upper housing portion 250. The upper spring stack 350 biases the upper adjuster 295 away from the carrier 345 (perhaps via one or more contact rings, washers, and/or other annular members 370), thus urging the interior profile 325 of the female latching portion 275 into contact with the exterior profile 330 of the plurality of flexible members 320, when the anti-release member 285 is positioned within the ends of the flexible members 320. The upper spring stack 350 also urges the female latching portion 275 (via the adjuster 295) toward contact with the separator 305, when permitted by engagement between the female and male latch portions 275, 280.

Thus, as explained in greater detail below: (1) the lower adjuster 340 is disposed in the second upper housing portion 250 at an axial location that is adjustable relative to the second upper housing portion 250 in response to rotation of the lower adjuster 340 relative to the second upper housing portion 250, (2) the upper spring stack 350 is operable to resist relative movement (and disengagement) of the female and male latch portions 275, 280, and (3) the lower spring stack 355 is also operable to resist relative movement (and disengagement) of the female and male latch portions 275, 280, wherein: (A) the female latch portion 275 is axially fixed relative to the second upper housing portion 250, (B) the male latch portion 280 is axially fixed relative to the second upper housing portion 250, (C) the difference between a first magnitude of the first impact force and a second magnitude of the second impact force is adjustable via adjustment of the relative locations of the female latch portion 275 and the upper adjuster 295 in response to relative rotation of the female latch portion 275 and the upper adjuster 295, and (D) the second magnitude of the second impact force is adjustable in response to adjustment of the location of the lower, “static” end of the lower spring stack 355 relative to the second upper housing portion 250, which is accomplished by adjusting the location of the lower adjuster 340 via rotation relative to the second upper housing portion 250 and/or connector 255.

Rotation of the female latch portion 275 relative to the second upper housing portion 250 may be via external access through an upper window 375 extending through a sidewall of the second upper housing portion 250. The upper window 375 may be closed during operations via one or more of: a removable member 380 sized for receipt within the window 375; and a rotatable cover 385 having an opening (not numbered) that reveals the window 375 when rotationally aligned to do so but that is also rotatable away from the window 375 such that the cover 385 obstructs access to the window 375. A fastener 390 may prevent rotation of the cover 385 during operations.

Rotation of the lower adjuster 340 relative to the second upper housing portion 250 may be via external access through a lower window 395 extending through a sidewall of the second upper housing portion 250. The lower window 395 may be closed during operations via one or more of: a removable member 405 sized for receipt within the window 395; and a rotatable cover 410 having an opening (not numbered) that reveals the window 395 when rotationally aligned to do so but that is also rotatable away from the window 395 such that the cover 410 obstructs access to the window 395. A fastener 415 may prevent rotation of the cover 410 during operations.

The detector housing 290 contains, for example, a detector 420 operable to detect the electrical characteristic based upon which the higher or lower impact force is imparted by the jarring tool 200 to the second tool string portion 150 (via the sensor tool 500). For example, as described above, the detector 420 may be operable to detect the presence of current and/or voltage on the electrical conductor 205, such as in implementations in which the detector is and/or comprises a transformer, a Hall effect sensor, a Faraday sensor, a magnetometer, and/or other devices operable in the detection of current and/or voltage. The detector 420 may be secured within the detector housing 290 by one or more threaded fasteners, pins, and/or other means 425.

The detector 420 also is, comprises, and/or operates in conjunction with a solenoid, transducer, and/or other type of actuator operable to move the anti-release member 285 between the first position (shown in FIG. 2) and the second position (not shown), below the first position, based on whether the electrical characteristic sensor of the detector 420 detects the electrical characteristic. In the example implementation depicted in FIG. 2, such actuator comprises a plunger 430 extending from the detector 420 and coupled to a mandrel 435 that slides axially with the plunger 430 inside the detector housing 290. The plunger 430 and mandrel 435 may be coupled via one or more threaded fasteners, pins, and/or other means 440, which may slide within a slot 292 extending through a sidewall of the detector housing 290. The mandrel 435 includes a recess 445 within which a retaining ring and/or other means 455 retains a head 450 of the anti-release member 285. A spring and/or other biasing member 460 disposed within the recess 445 urges the head 450 of the anti-release member 285 toward the retaining means 455 and/or otherwise resists upward movement of the anti-release member 285 relative to the mandrel 435.

The detector housing 290 and the mandrel 435 may each comprise one or more passages 294 through which the electrical conductor 205 may pass and then extend through the anti-release member 285 and the shaft 270. Accordingly, the electrical conductor 205 may be in electrical communication with the electrical conductors 505, 155 of the sensor tool 500 and the second tool string portion 150, respectively.

The anti-release member 285 may comprise multiple sections of different diameters. For example, the head 450 of the anti-release member 285 may have a diameter sized for receipt within the recess 445 of the mandrel 435 and containment therein via the retaining means 455. For example, a blocking section 465 of the anti-release member 285 may have a diameter sized for receipt within the male latch portion 280 (e.g., within the plurality of flexible members 320), such that the anti-release member 285 prevents disengagement of the female and male latch portions 275, 280 when the blocking section 465 is positioned within the male latch portion 280. For example, the blocking section 465 of the anti-release member 285 may be sufficiently sized and/or otherwise configured such that, when positioned within the ends of the plurality of flexible members 320, the flexible members 320 are prevented from deflecting radially inward in response to contact between the inner profile 325 of the female latch portion 275 and the outer profile 330 of each of the flexible members 320 of the male latch portion 280.

The detector 420, the plunger 430, the mandrel 435, and the biasing member 460 may also cooperatively operate to axially translate the anti-release member 285 between its first and second positions described above. For example, in the example implementation and operational stage depicted in FIG. 2, the blocking section 465 of the anti-release member 285 is positioned in the first position, including within the flexible members 320 of the male latch portion 280, such that the blocking section 465 of the anti-release member 285 prevents the radially inward deflection of the flexible members 320 and, thus, prevents the disengagement of the female and male latch portions 275, 280 until the tensile force applied across the jarring tool 200 sufficiently overcomes the biasing force(s) of the upper and/or lower spring stacks 350, 355. That is, to disengage the female and male latch portions 275, 280, the tensile force applied across the jarring tool 200 is increased by an amount sufficient to cause relative translation between the blocking section 465 of the anti-release member 285 and the male latch portion 280 by at least a distance 470 sufficient to remove the blocking section 465 of the anti-release member 285 from the ends of the flexible members 320 of the male latch portion 280, thereby permitting the radially inward deflection of the ends of the flexible members 320 and, thus, their disengagement from the female latch portion 275.

In the example implementation depicted in FIG. 2, the distance 470 is about 0.5 inches (or about 1.3 centimeters). However, the distance 470 may range between about 0.2 inches (or about 0.8 centimeters) and about 2.0 inches (or about 5.1 centimeters) within the scope of the present disclosure, and may also fall outside such range while nonetheless remaining within the scope of the present disclosure.

In other implementation and/or operational stage, the detector 420, the plunger 430, the mandrel 435, and/or the biasing member 460 may cooperatively translate the anti-release member 285 to its second position, such as in response to the detector 420 detecting a current, voltage, and/or other electrical characteristic of the electrical conductor 205. Consequently, the blocking section 465 of the anti-release member 285 may be positioned further inside (i.e., further downward) the male latch portion 280 relative to the first configuration depicted in the implementation/operational stage shown in FIG. 2. Accordingly, the distance 470 may be increased due to relative axial translation between the blocking section 465 and the ends of the flexible members 320 of the male latch portion 280. For example, the distance 470 may increase to about 0.8 inches (or about 2.0 centimeters). However, the increased distance 470 may range between about 0.3 inches (or about 0.8 centimeters) and about 4.0 inches (or about 10.1 centimeters) within the scope of the present disclosure, and may also fall outside such range while nonetheless remaining within the scope of the present disclosure.

As described above, the detector 420, the plunger 430, the mandrel 435, and/or the biasing member 460 may be collectively operable to move the blocking section 465 of the anti-release member 285 from the first position to (or at least toward) the second position. However, the detector 420, the plunger 430, the mandrel 435, and/or the biasing member 460 may also be collectively operable to return the blocking section 465 of the anti-release member 285 from the second position to (or at least toward) the first position. To facilitate such movement, the anti-release member 285 may also comprise an aligning section 480 having a diameter at least small enough to permit sufficient radially inward deflection of the ends of the flexible members 320, such as to consequently permit disengagement of the female and male latch portions 275, 280. The length of the aligning section 480 may vary within the scope of the present disclosure, but may generally be long enough that the end 485 of the anti-release member 285 remains within the male latch portion 280 and/or the shaft 270 during operation of the jarring tool 200.

The detector 420, the plunger 430, the mandrel 435, and/or the biasing member 460 may also be collectively operable to move the blocking section 465 of the anti-release member 285 to a third position between the first position and the second position. For example, the detector 420 may be operable to measure a quantitative value of the electrical characteristic of the electrical conductor 205, instead of (or in addition to) merely detecting the presence or absence of the electrical characteristic. Consequently, the extent to which the detector 420, the plunger 430, the mandrel 435, and/or the biasing member 460 collectively operate to move the blocking section 465 may be based on the measured quantitative value of the electrical characteristic of the electrical conductor 205. For example, the detector 420, the plunger 430, the mandrel 435, and/or the biasing member 460 may collectively operate to position the blocking section 465 of the anti-release member 285 in: the first position when the electrical characteristic of the electrical conductor 205 measured by the detector 420 is greater than a first predetermined level (e.g., a first predetermined current and/or voltage), the second position when the electrical characteristic of the electrical conductor 205 measured by the detector 420 is zero or less than a second predetermined level (e.g., a second predetermined current and/or voltage), and a third position between the first and second positions. The third position may be a single predetermined position between to the first and second positions, or may be one of multiple predetermined positions each corresponding to a quantitative interval between the first and second predetermined levels.

The detector 420, the plunger 430, the mandrel 435, and/or the biasing member 460 may also or instead collectively operate to position the blocking section 465 of the anti-release member 285 at a third position offset between the first and second positions by an amount proportional to the difference between the measured electrical characteristic and the first and second predetermined levels. For example, if the first predetermined level is ten (10) units (e.g., volts or amperes), the second predetermined level is zero (0) units, the measured electrical characteristic is three (3) units, and the distance between the first and second positions is about ten (10) centimeters, then the third position may be about three (3) centimeters from the second position, which is also about seven (7) centimeters from the first position.

FIG. 2 also depicts a floating piston 262 disposed within the annulus 264 defined between the outer profile of the shaft 270 and the inner profile of the third upper housing portion 260. The floating piston 262 may fluidly isolate a lower portion of annulus 264 below the floating piston 262 from an upper portion of the annulus 264. At least a portion of the annulus 264 may thus be utilized for pressure compensation of wellbore fluid and/or hydraulic oil contained within the jarring tool 200.

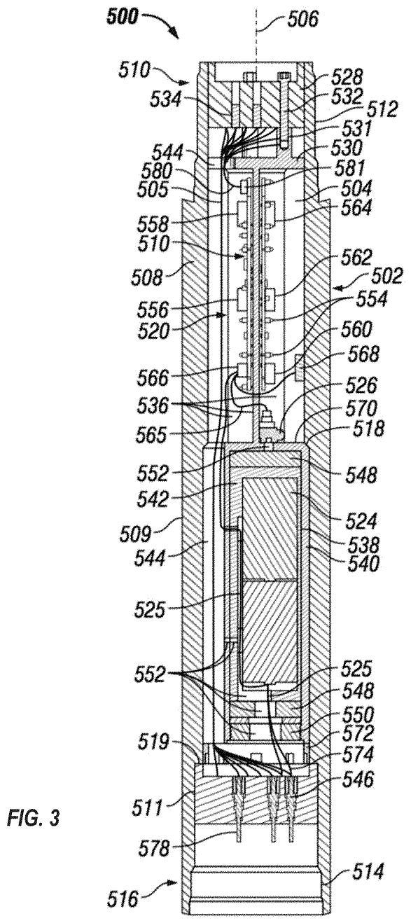

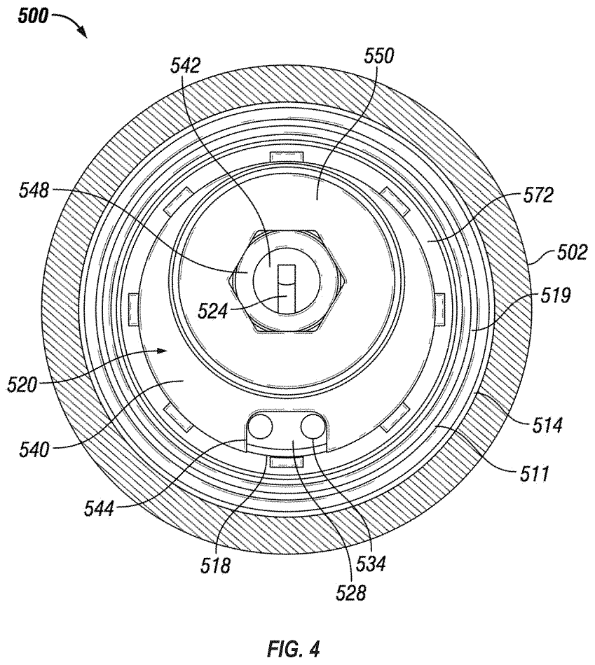

FIG. 3 is a sectional view of an example implementation of the sensor tool 500 shown in FIGS. 1 and 2 according to one or more aspects of the present disclosure. FIG. 4 is a bottom view of the sensor tool 500 shown in FIG. 3. For simplicity and clarity, FIG. 4 omits the lower electrical connector 546 to facilitate an improved view of some portions of the sensor tool 500.

Referring to FIGS. 1-4, collectively, the housing 502 of the sensor tool 500 may have a substantially tubular configuration. The housing 502 may comprise a first inner surface 508, a second inner surface 509, and a third inner surface 511 collectively defining a substantially cylindrical bore 504 (or multiple contiguous bores) extending longitudinally through the housing 502 along a central axis 506 of the sensor tool 500. The second inner surface 509 may comprise an inner diameter that is larger than an inner diameter of the first inner surface 508, and the third inner surface 511 may comprise an inner diameter that is larger than the inner diameter of the second inner surface 509. The housing 502 may further comprise a first shoulder 518 at the transition between the first inner surface 508 and the second inner surface 509, and a second shoulder 519 at the transition between the second inner surface 509 and the third inner surface 511. The first shoulder 518 may protrude radially into the bore 504 from the second inner surface 509 and extend circumferentially between the first and second inner surfaces 508, 509. The second shoulder 519 may protrude radially into the bore 504 from the third inner surface 511 and extend circumferentially between the second and third inner surfaces 509, 511.

The upper mechanical fastening means 512, located at the upper interface of the housing 502, may be operable to couple the sensor tool 500 with the lower mechanical fastening means 218 of the lower interface of the lower housing 265 of the jarring tool 200 or with other portion of the tool string 110. Although the upper mechanical fastening means 512 is shown as an external thread engaging the lower mechanical fastening means 218 of the jarring tool 200, other implementations of the upper mechanical fastening means 512 may include one or more fasteners, box-pin couplings, other oil field component field joints and/or coupling means, and/or other mechanical fastening means and/or interfaces known in the art. The lower mechanical fastening means 514, located at the lower interface of the housing 502, may be operable to couple the sensor tool 500 with the second portion 150 of the tool string 110 or with other portion of the tool string 110. Although the lower mechanical fastening means 514 is shown as an internal thread operable to threadedly engage a corresponding external thread (not shown), other implementations of the lower mechanical fastening means 514 may include one or more fasteners, box-pin couplings, other oil field component field joints and/or coupling means, and/or other mechanical fastening means and/or interfaces known in the art.

The sensor tool 500 further comprises an internal framing or support assembly, referred to herein as a chassis 520, to support or maintain one or more electronics boards 522, a power source 524, an accelerometer 526, and an upper electrical connector 528 in corresponding predetermined positions within the bore 504 of the housing 502. For example, an upper end of the chassis 520 may comprise a support member 530 that may aid in maintaining at least a portion of the chassis 520 centralized within the central bore 504 of the housing 502. The support member 530 may also function as a mounting bracket or surface, such as may maintain the upper electrical connector 528 in a predetermined position at or near the upper interface of the sensor tool 500. The support member 530 may comprise a plate or other member having a substantially cylindrical shape or otherwise have a curved outer surface that may facilitate contact with the cooperatively curved first inner surface 508 of the housing 502. The support member 530 may comprise an outer diameter that is sufficiently smaller than the inner diameter of the first inner surface 508 so as to permit the support member 530 to axially move within a corresponding portion of the bore 504 while minimizing radial movement within the corresponding portion of the bore 504. The support member 530 may comprise one or more threaded ports 531 for receiving one or more threaded bolts 532 to fixedly couple the upper electrical connector 528 to the support member 530 and, thus, in a predetermined position relative to the upper mechanical fastening means 512 of the upper interface.

The upper electrical connector 528 may comprise a plurality of sockets 534 electrically connected with the plurality of individual conductors of the electrical conductor 505. The plurality of sockets 535 may receive therein a plurality of pins from the upper or lower electrical connectors 212, 217 of the jarring tool 200, or from other portion of the tool string 110. Although one implementation of the upper electrical connector 528 is shown, the upper electrical connector 528 may be or comprise other electrical connectors known in the art, such as may be operable to mate or otherwise electrically connect with the electrical connectors 215, 217 of the jarring tool 200, the lower electrical connector (not shown) of the first portion 140, or an electrical connector of other portion of the tool string 110. In other implementation of the sensor tool 500, the upper electrical connector 528 may be omitted, wherein the individual conductors of the electrical conductor 505 may be spliced or otherwise connected with individual conductors of the electrical conductor 205 of the jarring tool 200 or other electrical conductor.

A lower end of the chassis 520 may comprise a receptacle portion 540 defining an open area or a cavity 538 containing the power source 524 and/or a container 542 containing the power source 524. The cavity 538 may have a substantially cylindrical shape, such as to permit the power source 524 and/or the container 542 to be slidably or otherwise disposed within the cavity 538. The receptacle portion 540 may have a substantially cylindrical shape, with an outer diameter that is sufficiently smaller than the outer diameter of the second inner surface 509 of the housing 502 so as to permit the receptacle portion 540 to axially move within a corresponding portion of the bore 504 while minimizing radial movement within the corresponding portion of the bore 504. An upper end of the receptacle portion 540 may comprise an edge or a shoulder 570, such as may contact the first shoulder 518 of the housing 502. The power source 524 may comprise one or more rechargeable batteries, such as lithium-ion batteries, and/or other means known in the art, such as may be operable to store electrical energy for powering components coupled to the electronics boards 522, the accelerometer 526, and/or other electrical components.

One or more damping members 548 may be disposed within the cavity 538 between the receptacle portion 540 and the power source 524 and/or the container 542, such as may aid in damping and/or otherwise reducing shock transmitted to the power source 524 during jarring and other operations. The damping members 548 may comprise rubber, polyether ether ketone (PEEK), and/or other damping material.

The power source 524, the container 542, and the damping members 548 may be retained within the cavity 538 by a fastener 550 operable to engage the receptacle portion 540. The fastener 550 may be or comprise a threaded retaining ring having external threads operable to engage corresponding internal threads of the receptacle portion 540 and, thus, prevent the power source 524, the container 542, and the damping members 548 from moving out of the cavity 538. One or more of the receptacle portion 540, the container 542, the damping members 548, and the fastener 550 may comprise one or more openings 552 extending therethrough, such as may permit leads, wires, and/or other electrical conductors 525 to extend from the power source 524 and communicate electrical power with one or more of the electronics boards 522, the accelerometer 526, and/or the electrical conductor 505 (such as to recharge the batteries of the power source 524).

Portions of the chassis 520 may further comprise cutout portions or channels 544 extending longitudinally with respect to the central axis 506. Such features 544 may, for example, permit the electrical conductor 505 to extend through the bore 504 between the housing 502 and the chassis 520 from the upper electrical connector 528 to the lower electrical connector 546.

In addition to (or instead of) using the power source 524 as the source of electrical power for the sensor tool 500, electrical power may be provided from the wellsite surface 105 to the sensor tool 500 via the conveyance means 160 and the electrical conductors 145, 205, 505. In such implementations, the sensor tool 500 may further comprise an electrical conductor 580 extending between the electrical conductor 505 and a power and communications interface 581 of one or more of the electronics boards 522. For example, individual wires of the electrical conductor 580 may be spliced or otherwise connected with selected individual conductors of the electrical conductor 505 within or at selected electrical sockets 534. The electrical power communicated through the conveyance means 160 and the electrical conductors 145, 205, 505, 580 may be utilized to operate electrical components of the sensor tool 500 and/or to reserve (or perhaps even recharge) the energy of the power source 524. In a similar implementation, the power source 524 may be omitted, wherein the electrical components of the sensor tool 500 may be powered solely from the wellsite surface 105 via the conveyance means 160 and the electrical conductors 145, 205, 505, 580.

The chassis 520 may further comprise one or more mounting plates 536 extending longitudinally within the bore 504 between the support member 530 and the receptacle portion 540. The mounting plates 536 may comprise one or more substantially planar surfaces, which may receive or abut one or more of the electronics boards 522. The mounting plates 536 may have sufficient thickness and/or strength so as to aid in preventing or minimizing flexing during jarring and other operations, which may aid in preventing or minimizing physical damage to the electronics boards 522.

The mounting plates 536 of the chassis 520 may comprise one or more openings (not shown) to receive one or more fasteners 554 operable to fixedly connect the electronics boards 522 to the mounting plates 536. The electronics boards 522 may comprise coupled thereto a processor 556, a memory device 558, and a plurality of sensors, such as a temperature sensor 560, a pressure sensor 562, and/or an inclination sensor 564. The electronics boards 522 may facilitate mounting of the sensors 560, 562, 564 on the chassis 520 and communication between the sensors 560, 562, 564, the processor 556, and the memory device 558. One or more of the sensors 560, 562, 564 may function as a detector for detecting a quality of an operating environment of the sensor tool 500, which may affect the measurement of the impact imparted by the jarring tool 200 during jarring operations. For example, during, prior to, or after the jarring operations, the sensors 560, 562, 564 may generate electrical output signals indicative of the quality of the operating environment, such as temperature, pressure, and inclination of the sensor tool 500. The output signals may be communicated to the processor 556 and the output signals or data generated by the processor may be stored on the memory device 558. This information may be utilized to calibrate the impact measurements determined via the accelerometer 526.

The sensor tool 500 may further comprise a load cell 568 or other strain measuring sensor connected to the second inner surface 509 of the housing 502. The load cell 568 may be operable to measure strain within the housing 502 during jarring and other operations. The strain data generated by the load cell 568 may be utilized to calculate the forces imparted into the sensor tool 500 and, therefore, the second portion 150 of the tool string 110 during jarring and other operations.

The accelerometer 526 may be mounted on the housing 502, one of the electronics boards 522, or the chassis 520, including the mounting plates 536 and the receptacle portion 540. The accelerometer 526 may comprise a one, two, or three-axis accelerometer operable to measure acceleration/deceleration of the housing 502 of the sensor tool 500 along the central axis 506 of the sensor tool 500 and/or along axes perpendicular to the central axis 506. The central axis 506 may substantially coincide with the longitudinal axis of the wellbore 120. The accelerometer 526 is operable to measure acceleration ranging between about 2000G and about 5000G. That is, the accelerometer 526 does not measure the shock and/or acceleration of normal handling of the sensor tool 500 and non-jarring operations of the tool string 110, which are generally less than about 1000G. The Applicant has determined that the accelerometers capable of accurately measuring the shock and/or acceleration of normal handling of the sensor tool 500 and non-jarring operations of the tool string 110 cannot also accurately measure the acceleration of jarring operations. Implementations within the scope of the present disclosure may also comprise multiple instances of the accelerometer 526, including implementations in which each accelerometer 526 may detect a different range of acceleration. The acceleration data generated by the accelerometer 526 may be utilized to calculate the impact forces imparted into the sensor tool 500 and, therefore, other portions of the tool string 110, during jarring operations.

The accelerometer 526 and the load cell 568 may be electrically or otherwise operably connected with one or more of the electronics boards 522 by leads, wires, and/or other electrical conductors 565 connected with other power and communications interface 566 of the electronics boards 522. The accelerometer 526 and the load cell 568 may generate electrical output signals indicative of quantities or parameters, such as acceleration and strain, experienced by the sensor tool 500 during jarring operations. The output signals may be communicated to the electronics boards 522, processed by the processor 556, and stored on the memory device 558.

Instead of storing the electrical output signals from the accelerometer 526 and/or the sensors 560, 562, 564, 568 on the memory device 558, the output signals may be communicated to the wellsite surface 105 in real-time through the electrical conductors 580, 505, 205, 145 and the conveyance means 160. For example, the output signals generated by the accelerometer and sensors described herein may be received by the electronics boards 522, processed, amplified, and communicated to the wellsite surface 105 through the electrical conductors 580, 505, 205, 145 and the conveyance means 160. Thereafter, the output signals may be analyzed at the wellsite surface 105 and/or recorded by the surface memory device 177. The electrical output signals may also be recorded by the downhole memory device 558 and simultaneously communicated to the wellsite surface 105, such as to be recorded by the surface memory device 177. The data stored on the memory device 558, communicated to the wellsite surface 105, and/or stored on the surface memory device 177 may include the raw data from the accelerometer(s) 526 and/or the sensors 560, 562, 564, 568, or processed data determined utilizing the raw data, such as in implementations in which the raw data from the accelerometer(s) 526 is calibrated to account for the potentially extreme temperature, pressure, strain, and/or other factors of the operating environment downhole during jarring operations.

In the context of assembling the sensor tool 500 prior to incorporation into the tool string 110, the first and the second inner surfaces 508, 509 of the housing 502 may be substantially smooth and/or otherwise permit the chassis 520 to be slidably inserted and moved axially along the bore 504 until the shoulder 570 of the chassis 520 contacts the first shoulder 518 of the housing 502. Once fully inserted into the bore 504, the chassis 520 may be retained in the bore 504 by a fastener 572 operable to engage the chassis 520 and the housing 502. The fastener 572 may be or comprise a threaded retaining ring having external threads operable to engage corresponding internal threads of the housing 502 and, thus, prevent the chassis 520 from moving out of the bore 504. Furthermore, the fastener 572 may comprise an opening 574 extending therethrough, such as may permit the electrical conductors 505, 525 to extend therethrough and electrically connect with the lower electrical connector 546.

Although FIG. 3 shows the chassis 520 as being a single, discrete member, the chassis 520 may also be formed from two or more separate and distinct portions. For example, the support member 530, the mounting plates 536, and the receptacle portion 540 may be separate and distinct portions coupled together via threaded engagement, fasteners, interference/press fit, and/or other fastening means.

As shown in FIG. 3, the lower electrical connector 546 may be operable to electrically connect the sensor tool 500 with the second portion 150 of the tool string 110. The lower electrical connector 546 may comprise a substantially cylindrical body and be disposed within the central bore 504 at or near the lower interface of the sensor tool 500. The lower electrical connector 546 may be disposed against the third inner surface 511 of the housing 502 and in contact with the second shoulder 519 protruding radially into the bore 504, such as to maintain the lower electrical connector 546 in a predetermined position with respect to the lower mechanical fastening means 514 of the lower interface. The lower electrical connector 546 may comprise a plurality of pins 578 extending therefrom and electrically connected with the plurality of individual conductors of the electrical conductor 505. The plurality of pins 578 may engage a plurality of sockets of the corresponding electrical connector (not shown) of the upper interface of the second portion 150 of the tool string 110. Although one implementation of the lower electrical connector 546 is shown, the lower electrical connector 546 may be or comprise other electrical connectors known in the art, such as may be operable to mate or otherwise electrically connect with the corresponding electrical connector of the upper interface of the second portion 150 of the tool string 110. The lower electrical connector 546 may also be omitted, such as in implementations in which the individual conductors of the electrical conductor 505 may be spliced or otherwise connected with individual conductors of the electrical conductor 155 of the second portion 150 of the tool string 110 or other electrical conductor.

In addition to the implementation shown in FIGS. 1 and 2, in which the sensor tool 500 is coupled below the jarring tool 200 (between the jarring tool 200 and the second portion 150 of the tool string 110), the sensor tool 500 may be coupled above the jarring tool 200, such as between the jarring tool 200 and the first portion 140 of the tool string 110. The sensor tool 500 may also be coupled between opposing portions of the first portion 140 of the tool string 110, between opposing portions of the second portion 150 of the tool string 110, above the first portion 140 of the tool string 110, or below the second portion 150 of the tool string 110. Multiple instances of the sensor tool 500 may also be incorporated into the tool string 110 at multiple locations, such as a first instance coupled between the first portion 140 of the tool string 110 and the jarring tool 200 and a second instance coupled between the jarring tool 200 and the second portion 150 of the tool string 110.

During operation of the tool string 110, the tool string 110 with the jarring tool 200 and the sensor tool 500 may be conveyed within the wellbore 120 that extends into the subterranean formation 130, as shown in FIG. 1. During such conveyance, the jarring tool 200 may be in the first configuration, as shown in FIG. 2, in which the detector 420 is detecting an electrical characteristic (e.g., current and/or voltage) from the electrical conductor 205, such as may be received via electronic communication with surface equipment 175 via the electrical conductor 145 of the first tool string portion 140 and the conveyance means 160. However, the jarring tool 200 may also be in the second configuration described above (not shown), in which the detector 420 is not detecting the electrical characteristic (or is detecting the absence of the electrical characteristic) from the electrical conductor 205. The operation of the jarring tool 200 may comprise actively setting or adjusting the jarring tool 200 between the first and second configurations, such as by operating the surface equipment 175 to establish the electrical characteristic detectable by the detector 420. During subsequent operations, the second tool string portion 150 may become lodged or stuck in the wellbore 120. Consequently, the jarring tool 200 may perform a power stroke when the jarring tool 200 is in either the first or second configuration.

During the power stroke, the tensioning device 170 of the surface equipment 175 is increasing the tension applied across the tool string 110 by pulling on the conveyance means 160. As the tension increases, the engagement between the female and male latch portions 275, 280 operates to overcome the biasing force of the upper and/or lower spring stacks 350, 355, thus causing the upper housing 242 to translate axially away from the lower housing 265. The tension is further increased in this manner by an amount sufficient for the blocking section 465 of the anti-release member 285 to emerge from within the ends of the flexible members 320 of the male latch portion 280, resulting in an impact actuation.

As stated above, such impact may be initiated in the first or “low-force” configuration of the jarring tool 200, when the detector 240 is detecting the electrical characteristic via the electrical conductor 205, or in the second or “high-force” configuration of the jarring tool 200 when the detector 240 is not detecting (or is detecting the absence of) the electrical characteristic. The resulting impact force is imparted to the lower tool string portion 150, such as along a load path extending from impact features 495 to the lower tool string portion 150 via the lower housing 265 and the housing 502 of the sensor tool 500.

In the first or “low-force” jarring tool configuration, the detector 420, the plunger 430, the mandrel 435, and/or the biasing member 460 may be collectively operated to move the blocking section 465 of the anti-release member 285 in the upward direction to decrease the distance 470 by which the upper and/or lower spring stacks 350, 355 may be compressed for the flexible fingers 320 to deflect radially inward and disengage from the female latch portion 275. Consequently, the upper ends of the flexible members 320 of the male latch portion 280 are able to deflect radially inward, thus permitting the disengagement of the female and male latch portions 275, 280, such that the upper housing 242 rapidly translates away from the lower housing 265 until one or more shoulders, bosses, flanges, and/or other impact features 490, connected to the shaft 270, collide with a corresponding one or more shoulders, bosses, flanges, and/or other impact features 495, connected to the third upper housing portion 260. During the jarring operations, one or more of the temperature sensor 560, the pressure sensor 562, the inclination sensor 564, the load cell 568, and the accelerometer 526 may generate one or more output signals related to or indicative of the impact imparted by the jarring tool 200 and/or the current operating environment of the sensor tool 500, as described above. The output signals may be recorded on the downhole memory device 558 and/or communicated to the wellsite surface 105, such as to be recorded on the surface memory device 177.

Operation of the jarring tool 200 may comprise multiple iterations of the “low-force” power stroke and reengagement of the female and male latch portions 275, 280 until the impact force iteratively imparted to the second tool string portion 150 is sufficient to dislodge the second tool string portion 150. However, the impact force imparted to the second tool string portion 150 by the jarring tool 200, when operating the jarring tool 200 in the first configuration, may not be sufficient to dislodge the second tool string portion 150. In such situations, the jarring tool 200 may then be set or adjusted to the second or “high-force” configuration, as described above, in which the detector 420 is not detecting the electrical characteristic (or is detecting the absence of the electrical characteristic) from the electrical conductor 205, so as to produce a “high-force” power stroke. In the second configuration, the jarring tool 200 and/or tool string 110 may be “turned off” such that the electrical characteristic is not detected by the detector 240, causing the blocking section 465 of the anti-release member 285 to extend downward further into the male latch portion 280 and therefore increase the distance 470. A greater tension may then be applied by the tensioning device 170 to the conveyance member 160 to compress the upper and/or lower spring stacks 350, 355 by the increased distance 470, such that the flexible fingers 320 may deflect radially inward and disengage from the female latch portion 275, thereby generating the “high-force” impact. Operation of the jarring tool 200 may then comprise multiple iterations of the “high-force” power stroke and reengagement the female and male latch portions 275, 280, until the impact force iteratively imparted to the lower tool string portion 150 is sufficient to dislodge the lower tool string portion 150.

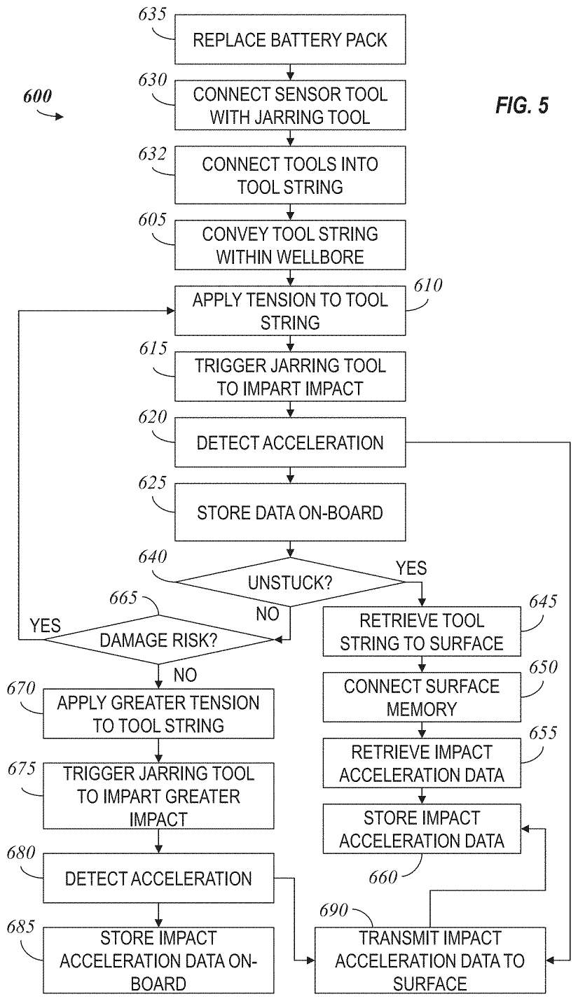

FIG. 5 is a flow-chart diagram of at least a portion of an example implementation of a method 600 according to one or more aspects of the present disclosure. The method 600 may be utilized to operate a jarring tool and a sensor tool, such as at least a portion of the jarring tool 200 and the sensor tool 500 shown in one or more of FIGS. 1-4. Thus, the following description refers to FIGS. 1-5, collectively.

The method 600 may comprise conveying 605 a tool string 110 comprising a jarring tool 200 and a sensor tool 500 within a wellbore 120 and applying 610 tension to the tool string 110, ultimately including triggering 615 the jarring tool 200 to impart an impact to the tool string 110. As described above, the jarring tool 200 may comprise a housing and a shaft 270. The housing may comprise an upper housing 242 and a lower housing 265 slidably connected by the shaft 270, and triggering 615 the jarring tool 200 to impart an impact to the tool string 110 may comprise triggering the jarring tool 200 such that the upper housing 242 rapidly moves in an upper direction relative to the lower housing 265 until the upper and lower housings 242, 265 collide, thus generating the impact imparted to the tool string 110.

As described above, the sensor tool 500 may comprise one or more accelerometers 526, one or more environment sensors 560, 562, 564, 568, and a memory device 558. The method 600 also comprises detecting 620 acceleration during the impact, via the accelerometer(s) 526, and storing 625 impact acceleration data generated by the accelerometer(s) 526 on the memory device 558. The detected 620 and stored 625 data may also include data from one or more of the environment sensors 560, 562, 564, 568.

The method 600 may further comprise connecting 630 the sensor tool 500 with the jarring tool 200 prior to conveying 605 the tool string 110 within the wellbore 120. For example, the lower mechanical fastening means 218 of the jarring tool 200 may be connected to the upper mechanical fastening means 512 of the sensor tool 500, and the one or more lower electrical connectors 217 of the jarring tool 200 may be connected with the one or more upper electrical connectors 528 of the sensor tool 500. The one or more lower electrical connectors 217 of the jarring tool 200 may be connected with the one or more upper electrical connectors 528 of the sensor tool 500 prior to connecting the lower mechanical fastening means 218 of the jarring tool 200 to the upper mechanical fastening means 512 of the sensor tool 500, or connecting the lower mechanical fastening means 218 of the jarring tool 200 to the upper mechanical fastening means 512 of the sensor tool 500 may simultaneously connect the one or more lower electrical connectors 217 of the jarring tool 200 with the one or more upper electrical connectors 528 of the sensor tool 500.

The method may further comprise connecting 632 the connected 630 jarring and sensor tools 200, 500 into the tool string 110. For example, the upper mechanical fastening means 212 of the jarring tool 200 may be connected to a corresponding interface of the first portion 140 of the tool string 110, and the lower mechanical fastening means 514 of the sensor tool 500 may be connected to a corresponding interface of the second portion 150 of the tool string 110. Such connecting 632 would further comprise connecting the one or more upper electrical connectors 215 of the jarring tool 200 with a corresponding lower electrical connector of the first portion 140 of the tool string 110, and connecting the one or more lower electrical connectors 546 of the sensor tool 500 with a corresponding upper electrical connector of the second portion 150 of the tool string 110. As above, the electrical connection may be made before making the mechanical connection, or making the mechanical connection may simultaneously make the electrical connection.

The method 600 may further comprise replacing 635 the battery pack 524 by disconnecting and removing the battery pack 524 from the chassis 520 and inserting and connecting a replacement battery pack 524 into the chassis 520. Such battery replacement 635 would be performed prior to connecting 632 the connected 630 jarring and sensor tools 200, 500 into the tool string 110.

The method 600 may also comprise determining 640 whether the stuck portion of the tool string 110 has become dislodged or unstuck. If it is determined 640 that the stuck portion of the tool string 110 has become dislodged, the method 600 may comprise retrieving 645 the tool string 110 to the wellsite surface 105. The method 600 may then comprise electrically connecting 650 a surface memory device 177 with the sensor tool 500, retrieving 655 the impact acceleration data from the downhole memory device 558, and storing 660 the impact acceleration data on the surface memory device 177.

If it is determined 640 that the stuck portion of the tool string 110 has not become dislodged, the method 600 may comprise assessing 665 the risk of damage to the tool string 110 by impact acceleration forces, such as by comparing the acceleration caused by the impact to a predetermined level of acceleration that the tool string 110 can operationally withstand. If it is determined 665 that the acceleration caused by the impact is at or near the predetermined level, the impact may be repeated by again applying 610 the tension to the tool string 110, including ultimately triggering 615 the jarring tool again impart the impact to the tool string 110. However, if it is determined 665 that the acceleration caused by the impact is substantially less than the predetermined level (e.g., by at least about twenty percent), then a second tension that is greater than the first tension (e.g., by about ten percent) may be applied 670 to the tool string 110, including ultimately triggering 675 the jarring tool to impart a second, greater impact to the tool string 110. In such instances, the method 600 may also comprises detecting 680 the greater acceleration during the second, greater impact, via the accelerometer(s) 526, and storing 685 impact acceleration data generated by the accelerometer(s) 526 on the memory device 558. The detected 680 and stored 685 data may also include data from one or more of the environment sensors 560, 562, 564, 568.

As described above, the tool string 110 may further comprise one or more electrical conductors 145, 205, 505, 155 extending between the jarring tool 200, the sensor tool 500, and a wellsite surface 105. The method 600 may further comprise transmitting 690 the impact acceleration data from the sensor tool 500 to the wellsite surface 105 through the one or more electrical conductors 145, 205, 505, 155, and storing 660 the acceleration data on the surface memory device 177, after one or more of the impact generation 615, 675, whether instead of or in addition to connecting 650 the surface memory device 177 with the sensor tool 500 and retrieving 655 the impact acceleration data from the downhole memory device 558.

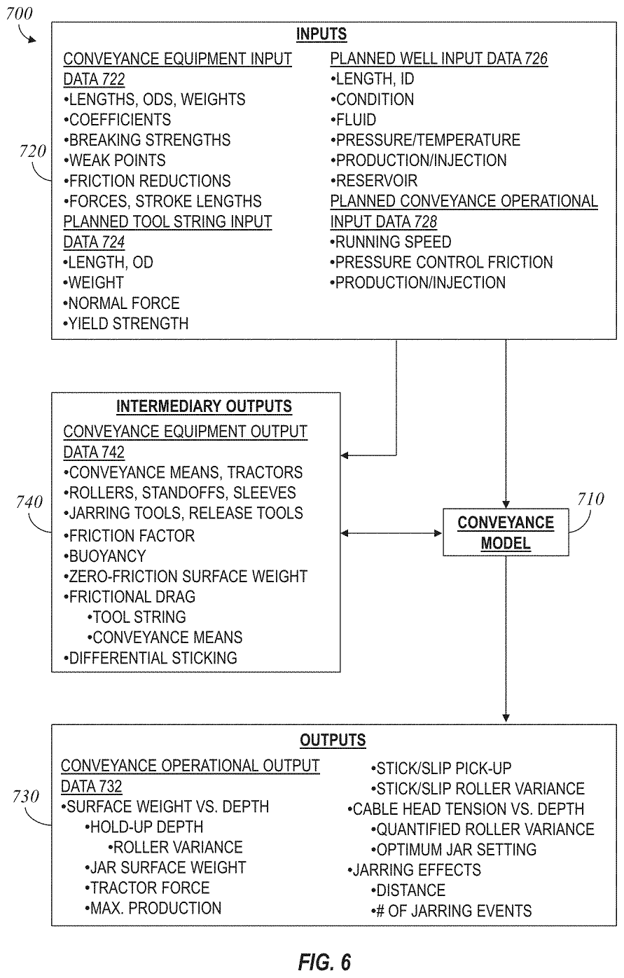

FIG. 6 is a schematic diagram of at least a portion of an example implementation of a conveyance job analysis engine 700 according to one or more aspects of the present disclosure. The engine 700 comprises a job conveyance model 710 that utilizes inputs 720 to generate outputs 730. In the example implementation depicted in FIG. 6, the inputs 720 include conveyance equipment input data 722 indicative of structural and/or operational characteristics of conveyance equipment that can be used to perform planned conveyance operations as part of or otherwise to facilitate a planned downhole job. The inputs 720 may further include planned tool string input data 724 indicative of structural and/or operational characteristics of a planned tool string that is planned to perform the planned downhole job. The inputs 720 may further include planned well input data 726 indicative of structural and/or operational characteristics of a planned well within which the planned tool string is planned to perform the planned downhole job. The inputs 720 may further include planned conveyance operational input data 728 indicative of planned operational parameters at which the planned conveyance operations are planned to be performed.

The conveyance equipment input data 722 may include physical and/or operational specifications of various conveyance means (e.g., coiled tubing, cable, wireline, slickline, multiline, etc.) that are operable (or that can be used) to perform conveyance operations, including the planned conveyance operations. The conveyance equipment input data 722 may include outer diameter (OD) of the conveyance means, weight (e.g., per unit length) of the conveyance means (e.g., in air), various coefficients descriptive of the conveyance means (e.g., stretch, elastic modulus, shear modulus, bulk modulus, Poisson's ratio, thermal expansion, etc.), breaking strength of the conveyance means, and/or weak point location(s). The conveyance equipment input data 722 may include physical and/or operational specifications of various friction reducing equipment (or means) that are operable to reduce friction between a sidewall of a well (including the planned well) and a tool string (including the planned tool string) and/or conveyance means. Such conveyance equipment input data 722 may include OD of the friction reducing equipment, weight of the friction reducing equipment, and/or coefficients of friction of the friction reducing equipment. The friction reducing equipment (or means) may include, for example, coatings, sleeves, standoffs, and roller devices. The conveyance equipment input data 722 may include physical and/or operational specifications of various jarring tools, linear actuators, tractors, release tools, fishing tool connectors, and flexible joint tools that are operable to be used (or connected) with a tool string, including the planned tool string. Such conveyance equipment input data 722 may include length, OD, weight, coefficient of friction, pulling or pushing force of the tractors and linear actuators, and/or impact force and/or stroke lengths of the jarring tools.

The planned tool string input data 724 may be applicable to the entire tool string, when assembled, and/or to individual tools, modules, and/or other components of the tool string, and may include length, OD (e.g., maximum OD, changes in OD (such as an outer profile), etc.), weight (e.g., in air), normal force (acting perpendicular to the well centerline), and yield strength. The planned well input data 726 may be applicable to the entire well and/or to individual, axially-extending sections of the well, and may include length, inner diameter (ID) of the well (such as minimum ID, changes in ID (such as an inner profile), etc.), information about the condition of the well (e.g., open-hole or cased, mudcake condition (e.g., thickness) etc.), information about fluid (including gas) in the well (e.g., composition, pressure, temperature, density, viscosity, etc.), pressure and/or temperature at the top and/or bottom of the well, information about production into the well from the intersected reservoir(s)/formation(s) and/or injection from the well into the intersected reservoir(s)/formation(s) (e.g., fluid (including gas) composition, pressure, temperature, density, viscosity, flow rate, etc.), and information about the reservoir(s)/formation(s) intersected by the well (e.g., boundary depths, pressure, temperature, skin factor, permeability, etc.). The planned conveyance operational input data 728 may include planned conveyance (or running) speed, planned conveyance depth, planned conveyance time, planned friction of pressure control, and information about planned production from the well to surface equipment and/or planned injection into the well from surface equipment (e.g., fluid (including gas) composition, pressure, temperature, density, viscosity, flow rate, etc.).

The inputs 720 may vary from the example implementation depicted in FIG. 6. For example, the inputs 720 may also include information obtained via one or more of the sensors described above, whether in addition to or instead of one or more of the inputs 720 depicted in FIG. 6. The inputs 720 may also include information obtained via human experience, such as empirical evidence obtained during testing (e.g., lab testing) and/or actual operations performed in the well and/or other wells. The inputs 720 may include those described above and/or shock (e.g., high and/or low frequency acceleration), tension and/or compression (high and/or low frequency), inclination, pressure, temperature, radial orientation, friction, velocity, torque, vibration, fluid parameters (e.g., viscosity, weight, pressure temperature, density, bubble point, saturation point, dew point, etc.), well bore geometry (e.g., diameter, cross-sectional shape, trajectory, etc.), depth, and/or other determined (measured and/or otherwise obtained) inputs hereby deemed to also be within the scope of the present disclosure.

One or more of the inputs 720 may be entered manually into the conveyance model 710 or one or more of the inputs 720 may be automatically pushed into the conveyance model 710 from a processing device and/or other device storing the inputs 720. The conveyance equipment input data 722 may be stored in a database or a memory device. The conveyance equipment input data 722 may then be transmitted to and/or accessed by the conveyance model 710 to generate outputs, including the outputs 730.

The engine 700 may also utilize intermediary outputs 740 calculated, selected, and/or otherwise determined based on the inputs 720. The intermediary outputs 740 may be determined via the conveyance model 710, another part of the conveyance analysis engine 700, human personnel (e.g., a human operator), and/or otherwise. For example, the determined intermediary outputs 740 may include determined conveyance equipment output data 742 comprising equipment data indicative of conveyance equipment determined to be used to perform the planned conveyance operations. The conveyance equipment output data 742 may include a listing of conveyance equipment determined (or selected) by the conveyance model 710 to be used to perform the planned conveyance operations. The determined conveyance equipment output data 742 may be indicative of which conveyance means (e.g., coiled tubing, cable, wireline, slickline, multiline, etc.) to use, which and/or how many friction reducing conveyance equipment (if any) (e.g., roller devices, standoffs, sleeves, etc.) to use, which and/or how many tractors (if any) to use, which and/or how many jarring tools to use, which and/or how many linear actuators to use, which and/or how many release tools to use, and/or which cable head to use.

The conveyance equipment output data 742 may further comprise operational data indicative of various operational parameters associated with the conveyance equipment determined (or selected) to be used to perform the planned conveyance operations and indicated in the conveyance equipment output data 742. The determined operational data may be based on the determined conveyance equipment, the planned tool string input data 724, the planned well input data 726, and/or the planned conveyance operational input data 728. The operational data may include, for example, friction data indicative of friction and/or friction factor between the well and the determined conveyance equipment. The friction factor may be based on the determined conveyance equipment, the planned tool string input data 724, the planned well input data 726, and/or the planned conveyance operational input data 728, including information about the well/section condition and fluid/gas therein, and/or other information. The operational data may include buoyancy information, such as the buoyant weight of the tool string and conveyance means determined based on the determined conveyance equipment and the planned well input data 726 (such as about fluid/gas in the well), including information about pressure and/or pressure control in the planned well. The operational data may include a zero-friction surface weight estimate or prediction, such as may be determined via the resolution of the forces acting in the planned well, including the buoyant weight of the planned tool string and the determined conveyance equipment times depth at deviation. The operational data may include frictional drag (e.g., mechanical and/or from fluid in the well) on the planned tool string and the determined conveyance equipment. For example, the frictional drag may include mechanical drag estimated, determined, and/or otherwise based on normal force times a friction coefficient (e.g., dynamic), and/or fluid-based drag based on fluid pressure drag, form drag, and/or shear drag. The operational data may include differential sticking forces, such as based on pressure differential (reservoir to well), mud cake factor, and area of the tool string in contact with the sidewall of the planned well.

The outputs 730 of the conveyance model 710 may be based on one or more of the inputs 720 and/or one or more of the intermediary outputs 740. The outputs 730 may include conveyance operational output data 732 indicative of operational parameters at which the planned conveyance operations are determined to be performed. The conveyance operational output data 732 may include operational parameters at which the determined conveyance equipment indicated in the conveyance equipment output data 742 is to be performed to perform or otherwise facilitate the planned conveyance operations.

The conveyance operational output data 732 may include a graph and/or other data indicative of how a determined (e.g., estimated, calculated, predicted, etc.) surface weight (e.g., weight of the planned tool string and the determined conveyance means as measured by surface equipment) varies versus depth of the planned tool string (e.g., at the bottom end, the cable head, the midpoint, and/or other component of or location within the planned tool string). For example, the surface weight versus depth information may be the zero-friction result+/−mechanical drag+/−fluid drag. The surface weight versus depth information may include, or be utilized to determine, a hold-up depth of the planned tool string (perhaps with and without roller devices, standoffs, and/or other friction reduction means), a surface weight required to fire a determined jarring tool included in the planned tool string, a tractor force required to pull the planned tool string to an intended depth in the planned well, the maximum allowable production rate, the maximum pick-up weight required to overcome stick/slip, and/or how the determined roller devices, standoffs, and/or other friction reduction devices (or means) in the planned tool string effect the stick/slip effect, and/or other information.

The determined conveyance operational output data 732 may also or instead include cable head tension versus depth in the planned well, such as the difference between the resolved force of the planned tool string pulling in the planned well and the drag of the determined conveyance means. The cable head tension versus depth information may include, or be utilized to determine, quantified differences resulting from adding roller devices, standoffs, and/or other friction reduction means to the planned tool string, optimum jarring tool settings, maximum allowable pump down rate, and/or other information.

The determined conveyance operational output data 732 may also or instead include jarring force and/or other effects delivered to the planned tool string, such as may be the product of (or otherwise based on) jarring tool settings and/or impact ratio. This jarring information may include the distance moved by the determined jarring tool (and/or other portions of the planned tool string) during each activation of the determined jarring tool, and perhaps the number of jarring events determined as necessary to overcome differential sticking of at least a portion of the planned tool string and/or the determined conveyance means.

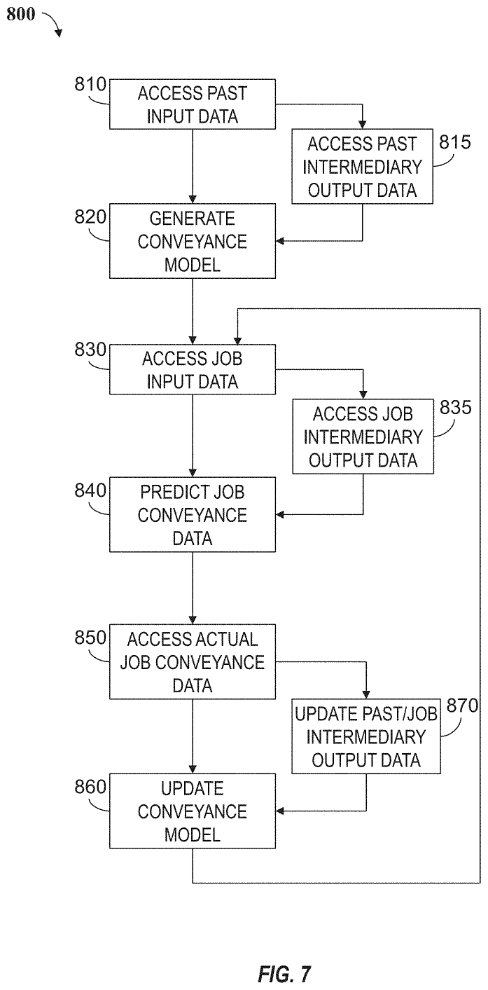

FIG. 7 is a flow-chart diagram of at least a portion of an example implementation of a method 800 according to one or more aspects of the present disclosure. The method 800 may be utilized in conjunction with at least a portion of the apparatus shown in one or more of FIGS. 1-4, at least a portion of the method shown in FIG. 5, the engine 700 and/or model 710 shown in FIG. 6, and/or other aspects within the scope of the present disclosure.

The method 800 may include accessing 810 past (or historical) input data. The accessed 810 past input data may include multiple sets of the inputs 720 depicted in FIG. 6, and/or other data described herein, with each set corresponding to one or more past conveyance operations (or jobs) in one or more wells. Each such operation may include running a tool string into a well to an intended depth (RIH), pulling the tool string out of the well (POOH), portions of an RIH or POOH, or combinations of such movements of the tool string within the well.

The method 800 may also include accessing 815 past intermediary output data, such as may include multiple sets of the intermediary outputs 740 depicted in FIG. 6, and/or other data described herein, with each set corresponding to the same operations/wells of the accessed 810 past input data. Accessing 815 the past intermediary output data may also or instead include generating one or more such sets of intermediary outputs 740 utilizing the accessed 810 past input data.

The method 800 may also include generating 820 a conveyance model. The generated 820 conveyance model may be or include an instance of the conveyance model 710 generated via the engine 700 of FIG. 6. However, other methods may also or instead be utilized to generate 820 the conveyance model.

Generating 820 the conveyance model may include preprocessing the accessed 810 past input data and/or the accessed 815 past intermediary output data. For example, the accessed 810 past input data and/or the accessed 815 past intermediary output data may be filtered by selecting data sets that correspond to one or more parameters of wells (e.g., well types, conditions, dimensions, etc.), tool strings, and/or operations, such as sets of the accessed 810 past input data and/or the accessed 815 past intermediary output data in which one or more of the inputs 720 and/or outputs 740 have values within predetermined ranges and/or satisfying other conditions. Thus, the filtering may select data sets in which values for one or more of the OD, weight, coefficient(s), breaking strength, weak point, friction reduction, and/or other parameters related to the conveyance equipment, one or more of the length, OD, weight, friction reduction, normal force, yield strength, stroke length, and/or other parameters related to the tool string, one or more of the length, ID, condition, fluid, pressure, temperature, production/injection, reservoir, and/or other parameters related to the well, and/or one or more of the running speed, pressure control friction, production/injection, and/or other parameters related to conveyance operations each fall within maximum and minimum thresholds. The maximum and minimum thresholds utilized for such filtering may be predetermined or entered in real-time, and may also vary based on different types of the applicable conveyance equipment, tool string, well, and/or other equipment, and/or for different conveyance scenarios, operating companies, geographic locations, and/or other variables.

The preprocessing may also or instead comprise downsampling. For example, such downsampling may comprise randomly or otherwise selecting a percentage of the accessed 810 past input data and/or the accessed 815 past intermediary output data. Such downsampling may aid in removing noise from the accessed 810 past input data and/or the accessed 815 past intermediary output data, and/or in detecting trends in the accessed 810 past input data and/or the accessed 815 past intermediary output data before and/or after preprocessing.

The preprocessing may also or instead comprise temporally aligning the data relative to each other. Such alignment may be utilized to align known and/or predicted features in the data (e.g., peaks, valleys, plateaus, slopes, curves, etc., in the data, or in derivatives, integrals, and/or other mathematical operations on the data) with respect to time, and/or to account for different sampling frequencies existing within the accessed 810 past input data and/or the accessed 815 past intermediary output data. The temporal alignment and/or other aspect of the preprocessing may otherwise provide general formatting to put the data into a form that can be fed into a machine learning algorithm, for example.

The method 800 includes accessing 830 planned (or current) job input data. The accessed 830 job input data may include one or more of the inputs (e.g., the inputs 720 in FIG. 6), sensor measurements, and/or other variables described above. The method 800 may also include accessing 835 planned (or current) job intermediary output data, such as may include multiple sets of the determined intermediary outputs 740 depicted in FIG. 6, and/or other data described herein, with each set corresponding to the same operations/wells of the accessed 830 job input data. The planned job intermediary output data may be generated by a processing device executing computer program code (e.g., the conveyance model 710). Thus, accessing 835 the job intermediary output data may also or instead include generating one or more such sets of intermediary outputs 740 utilizing the generated 820 conveyance model and the accessed 830 job input data. Accessing 835 the job intermediary output data may therefore include determining (or selecting) conveyance equipment data (e.g., the conveyance equipment output data 742) indicative of conveyance equipment to be used to perform the planned job and the corresponding operational data indicative of various operational parameters or specifications associated with the conveyance equipment determined to be used to perform the planned job. The determining of conveyance equipment data may include determining which conveyance equipment is operable to perform the planned job in an intended manner based on predetermined parameters (e.g., the planned conveyance operational input data 728).

The accessed 830 job input data and/or the accessed 835 job intermediary output data are then utilized with the generated 820 model to predict (or determine) 840 job conveyance data for a planned job. The predicted 840 job conveyance data may include one or more of the inputs (e.g., the inputs 720 in FIG. 6), intermediary output data (e.g., the intermediary outputs 740 in FIG. 6), sensor measurements, output data (e.g., the outputs 730 in FIG. 6), and/or other variables described above. For example, the accessed 810 past input data and/or the accessed 815 past intermediary output data may include data that is indicative of a first parameter and a plurality of second parameters of the planned job for which conveyance data is being predicted 840. The accessed 810 past input data and/or the accessed 815 past intermediary output data may include values for the first and second parameters for past jobs, and the conveyance model generated 820 with the accessed 810 past input data and/or the accessed 815 past intermediary output data may be utilized to predict a value(s) of the first parameter based on values for the second parameters in the accessed 830 job input data. Thus, predicting 840 the job conveyance data may utilize values of the second parameters in the accessed 830 job input data as inputs to the generated 820 conveyance model, which then predicts the value(s) of the first parameter(s) missing from the accessed 830 job input data.

The generated 820 conveyance model may include different models utilized for different aspects of the conveyance operations of the planned job. For example, different models may be utilized for RIH versus POOH, cased hole versus open-hole, different service companies, and/or the inclusion versus exclusion of roller devices, standoffs, and/or other friction reduction means, among other examples hereby deemed to also be within the scope of the present disclosure. Multiple predictive models may also be utilized for different sections of the well.

Generating 820 the conveyance model may include analytically identifying correlations between operational parameters available from previously analyzed conveyance operations represented by the accessed 810 past input data and/or the accessed 815 past intermediary output data. Generating 820 the conveyance model may then include adjusting fitting parameters of the model (e.g., iteratively) to exploit correlations between each of the first and second operational parameters in the accessed 810 past input data and/or the accessed 815 past intermediary output data to optimize prediction performance of the conveyance model.

For example, the accessed 810 past input data and/or the accessed 815 past intermediary output data may be utilized to generate multiple feature-selection models, each predicting a corresponding one of the available operational parameters utilizing other ones of the available operational parameters. Thus, if there are twenty operational parameters available in the training data, then twenty feature-selection models may be generated. The first and second operational parameters may then be selected based on the correlation exhibited by the feature-selection models. That is, the one (or more) of the generated feature-selection models that exhibits the closest correlation between parameters may be selected. Selecting the first and second operational parameters may also be based on physical assumptions based on human observations of prior operations in the field and/or prior maintenance operations.

Selecting the first and second operational parameters based on correlation of the generated feature-selection models, however, may include first selecting the first operational parameters (the operational parameter for which data will be predicted 840), and then selecting which of the remaining operational parameters will be used for model inputs. Using each available input to model the predicted output data is an option. However, it may be the case that just a few of the inputs contribute to the majority of the output variability. By removing data inputs that are unrelated and/or have small correlations to the desired output, modeling can be performed more quickly and more efficiently, and with less noise that may hinder the results of the analysis. Moreover, two or more inputs may be combined to create new parameters (e.g., intermediary data) that may improve results.

However, other processes may also or instead be utilized for generating 820 the predictive conveyance model. Such processes may include statistical and/or physics-based tools and methods able to take in selected first operational parameters of the past data and/or the intermediary output data and then provide a prediction for the output. Physics-based modeling may utilize traditional physics equations derived from first principles to describe the behavior of a given system, and may provide insight into the physical behavior of the system and how that system is failing. However, in most complex systems with high dimensional data, first principal models have not been formulated, and determining the relationship between a given output and a large number of input parameters may not be a feasible task. In such scenarios, data driven, machine learning, and/or other statistical modeling techniques can be used with the accessed 810 past input data and/or the accessed 815 past intermediary output data to train a model by feeding the algorithm data and then iteratively adjusting a set of model parameters in order to minimize the model error as compared to the accessed 810 past input data and/or the accessed 815 past intermediary output data. Such methods may improve performance by finding correlations between the input data and a given output and then use the correlation strength to weight the input parameters. Generating 820 the conveyance model may also include normalizing the accessed 810 past input data and/or the accessed 815 past intermediary output data along multiple dimensions to improve model performance.

The method 800 may also include accessing 850 actual job conveyance data. The accessed 850 job conveyance data may be utilized to update 860 the previously generated 820 conveyance model. For example, differences between the predicted 840 job conveyance data and the accessed 850 actual job conveyance data may be utilized to tweak coefficients, rules, relationships, formulas, algorithms, and/or other aspects of the generated 820 conveyance model. The accessed 850 job conveyance data may also or instead be utilized to update 870 coefficients, rules, relationships, formulas, algorithms, and/or other aspects of the previously accessed 815 past intermediary output data and/or the previously accessed 835 job intermediary output data, which may then be utilized to update 860 the conveyance model. The updated 860 conveyance model may then be utilized with previously or newly accessed job input data to predict conveyance data of the same or other conveyance job.

Different aspects of the method 800 may be performed by different actors (e.g., different people, different computers, different companies, etc.). For example, a first company may access 810 the past input data and/or access 815 the past intermediary output data and generate 820 the conveyance model, a second company may access 830 the job input data, access 835 the job intermediary output data, and predict 840 the job conveyance data, a third company may access 850 the actual job conveyance data, and a fourth company may update 855/860 the intermediary output data and/or conveyance model. Alternatively, one company, or some other combination of companies, may perform all or portions of the method 800.

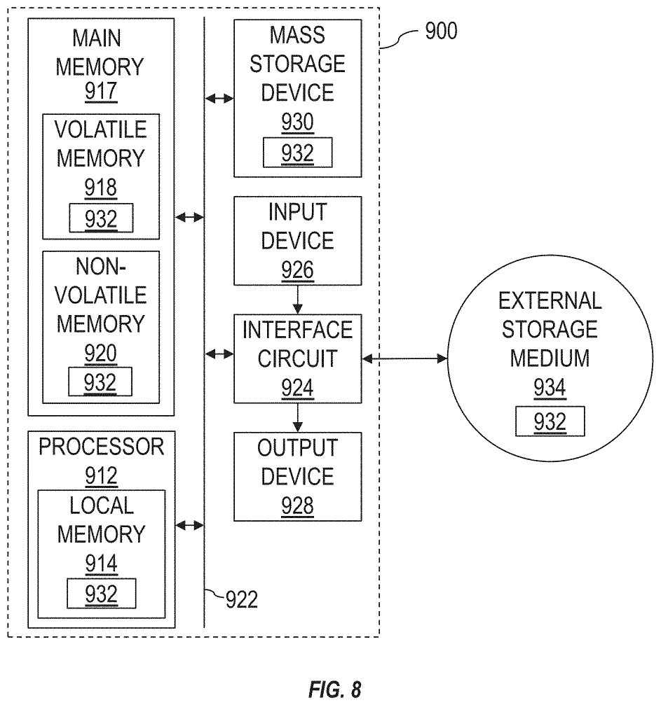

FIG. 8 is a block diagram of at least a portion of an example implementation of a processing system 900 according to one or more aspects of the present disclosure. One or more instances of the processing system 900 may be in wired or wireless communication with the sensors, components, and/or other apparatus shown in one or more of FIGS. 1-4 and/or other apparatus within the scope of the present disclosure, whether the processing system 900 (or instance or portion thereof) is located at or remote from a wellsite. One or more instances of the processing system 900 may be operable to execute machine-readable instructions to perform at least a portion of the method 600 shown in FIG. 6, the engine 700 shown in FIG. 6, the method 800 shown in FIG. 7, and/or other methods within the scope of the present disclosure. One or more instances of the processing system 900 may be operable to implement at least a portion of one or more of the example apparatuses described herein. The processing system 900 may be or comprise, for example, one or more processors, special-purpose computing devices, servers, personal computers, laptop computers, tablet computers, personal digital assistant (PDA) devices, smartphones, internet appliances, and/or other types of computing devices.

The processing system 900 may comprise a processor 912, such as a general- or special-purpose, programmable processor. The processor 912 may comprise a local memory 914, and may execute coded instructions 932 present in the local memory 914 and/or other memory device of the processing system 900. The processor 912 may be, comprise, or be implemented by one or a plurality of processors of various types suitable to the local application environment, and may include one or more of general-purpose processors or computers, special-purpose processors or computers, microprocessors, digital signal processors (DSPs), field-programmable gate arrays (FPGAs), application-specific integrated circuits (ASICs), and processors based on a multi-core processor architecture, as non-limiting examples. Of course, other processors from other families are also appropriate.

The processor 912 may be in communication with a main memory 917, such as may include a volatile memory 918 and a non-volatile memory 920, perhaps via a bus 922 and/or other communication means. The volatile memory 918 may be, comprise, or be implemented by random access memory (RAM), static random-access memory (SRAM), synchronous dynamic random access memory (SDRAM), dynamic random access memory (DRAM), RAMBUS dynamic random access memory (RDRAM), flash memory, and/or other types of memory devices. The non-volatile memory 920 may be, comprise, or be implemented by read-only memory, flash memory, and/or other types of memory devices. One or more memory controllers (not shown) may control access to the volatile memory 918, the non-volatile memory 920, and/or other portions or components of the main memory 917. The processing system 900 may be operable to store or record (e.g., on the main memory 917) information entered by human personnel and/or generated by the sensors of a wellsite system and/or other systems within the scope of the present disclosure.

The processing system 900 may also comprise an interface circuit 924. The interface circuit 924 may be, comprise, or be implemented by various types of standard interfaces, such as an Ethernet interface, a universal serial bus (USB), a third-generation input/output (3GIO) interface, a wireless interface, a cellular interface, and/or a satellite interface, among other examples. The interface circuit 924 may also comprise a modem, a network interface card, and/or other communication devices to facilitate exchange of data with external computing devices via one or more networks (e.g., Ethernet connection, digital subscriber line (DSL), telephone line, coaxial cable, cellular telephone system, satellite, etc.). For example, the sensors and/or other components of a system according to one or more aspects of the present disclosure may be connected with the processing system 900 via the interface circuit 924.

One or more input devices 926 may also be connected to the interface circuit 924. The input devices 926 may permit human personnel to enter the coded instructions 932, operational set points, and/or other data into the processing system 900. The input devices 926 may each be, comprise, or be implemented by a keyboard, a mouse, a touchscreen, a track-pad, a trackball, a camera, a voice recognition system, and/or an audio and/or visual recording device, among other examples.

One or more output devices 928 may also be connected to the interface circuit 924. The output devices 928 may each be, comprise, or be implemented by a display device (e.g., a light-emitting diode (LED) display, a liquid crystal display (LCD), or a cathode ray tube (CRT) display), printer, and/or speaker, among other examples.

The processing system 900 may also connect with or comprise one or more mass storage devices 930 and/or a removable storage medium 934. Each mass storage device 930 and/or removable storage medium 934 may be, comprise, or be implemented by at least a portion (e.g., sector) of a floppy disk drive, a hard disk drive, a compact disk (CD) drive, a digital versatile disk (DVD) drive, and/or a USB and/or other flash drive, among other examples.

The coded instructions 932, the operational set points, and/or other data may be stored in the mass storage device 930, the volatile memory 918, the non-volatile memory 920, the local memory 914, and/or the removable storage medium 934. Thus, components of the processing system 900 may be implemented in accordance with hardware (perhaps implemented in one or more chips including an integrated circuit, such as an ASIC), or may be implemented as software or firmware for execution by the processor 912. In the case of software or firmware, the implementation may be provided as a computer program product including a non-transitory, computer-readable medium embodying computer program code (i.e., software or firmware) thereon for execution by the processor 912.

An example conveyance model product is described below. However, it is to be understood that the following is merely an example, and that variations of the following example are also within the scope of the present disclosure.

The example product includes a web-based force and drag model, including at least basic hydraulics. The model may be operable to predict, calculate, obtain, and/or otherwise determine (hereafter collectively “determine”) intermediary outputs, including conveyance equipment data (e.g., the determined conveyance equipment output data 742) indicative of conveyance equipment to be used to perform the planned job and the various operational parameters or specifications associated with the conveyance equipment determined to be used to perform the planned job. The conveyance equipment data may include a listing of conveyance equipment determined to be used to perform the planned conveyance operations. The determined conveyance equipment data may be indicative of which conveyance means (e.g., coiled tubing, cable, wireline, slickline, multiline, etc.) to use, which and/or how many friction reducing conveyance equipment (if any) (e.g., roller devices, standoffs, sleeves, etc.) to use, which and/or how many tractors (if any) to use, which and/or how many jarring tools to use, which and/or how many linear actuators to use, which and/or how many release tools to use, and which cable head to use.

The model may be further operable to determine conveyance outputs, including conveyance operational data (e.g., the determined conveyance operational output data 732) indicative of operational parameters at which the planned conveyance operations are determined to be performed by the determined conveyance equipment indicated in conveyance equipment output data (e.g., the conveyance equipment output data 742). The determined conveyance operational data may include the maximum achievable depth of a downhole tool/tool string, with and without roller devices (and/or other optional friction reduction means). The model may also or instead be able to determine one or more optimal jarring tool settings. The model may also or instead be able to determine the tractor force required to pull the tool/tool string to a desired depth (e.g., total depth, or TD), such as for scenarios in which the depth is not attainable by gravity alone. The model may also or instead be able to determine an at least basic differential sticking force for independent permeable zones, such as in open-hole scenarios. The model may also or instead be able to determine the production rate that would lift the tool/tool string when the tool/tool string was stationary, and/or the production rate that would prevent downhole passes. The model may also or instead be able to determine the injection rate range that could be successfully utilized to pump the tool/tool string to the desired depth (e.g., TD), but without breaking the weak point/50% breaking strength.

One or more of such results may be output via a surface weight graph from surface to the desired depth (e.g., TD) for run in and pull out, perhaps including a hold-up line. The graph may also include a curve representing 50% of breaking strength, and/or a curve representing jarring tool firing force. One or more of the results may also or instead be output via a cable head tension graph from surface to the desired depth (e.g., TD) for run in and pull out. One or more of the results may also or instead be output via stretch profile from surface to the desired depth (e.g., TD) for run in and pull out. Such outputs may also be accompanied by a summary of the simulation/model inputs.

The model may permit the user to vary tool/tool string friction independent of well friction. The model may also or instead permit the user to vary conveyance means friction independent of the tool/tool string and/or well friction. The model may also or instead permit the user to select the display (or otherwise output) comparative results for different inputs on the same graphical outputs (and/or other output types). The model may also or instead permit the user to enter multiple “permeable zone” depths and pressures, such as for open-hole scenarios. The model may also or instead permit the user to choose from a limited selection of fluids contained in the well, such as gas, oil, water, brine, oil- or water-based mud, fracturing fluid, workover fluid, and/or other examples.

The model may be utilized by human personnel via one or more front end user interfaces permitting inputs as described above. Such inputs may include, for example: well input data (e.g., IDs at different depths, the well medium, pressure and/or temperature at the top and/or bottom of the well, and/or well condition) indicative of a planned well within which the planned tool string is planned to perform the planned downhole job; tool string input data (e.g., ODs, lengths, weights, friction reduction means, and/or centrality in the well) indicative of a planned tool string that is planned to perform the planned downhole job; conveyance equipment input data (e.g., OD, weight in air, stretch, and/or breaking strength) indicative of conveyance equipment that can be used to perform planned conveyance operations as part of or otherwise to facilitate a planned downhole job; and/or planned conveyance operational data indicative of planned operational parameters at which the planned conveyance operations are planned to be performed. One or more of these and/or other example inputs may be entered each time the simulation is run. However, one or more of these example inputs (e.g., the conveyance equipment input data) may be determined via libraries or databases (and/or respective back-end interfaces). The inputs may be recorded in a database for retrieval later, such as stored by job/project number, user identification, job/project name, secondary (e.g., user-specific) job/project number, and/or other parameters, such as in implementations permitting later analytics.

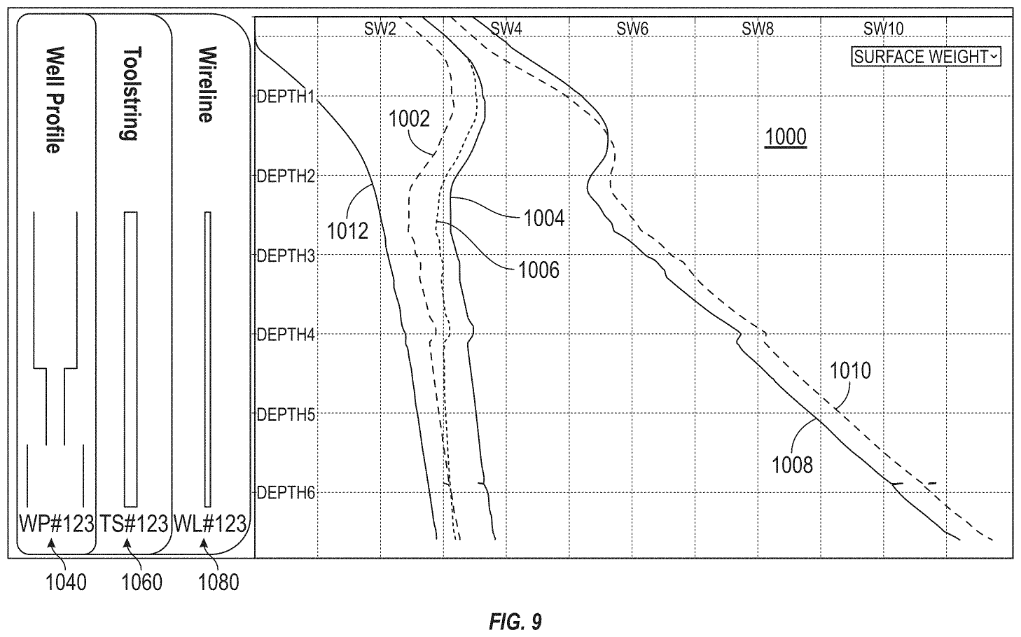

This example product may utilize a user interface, such as (or similar to) the example user interface depicted in FIGS. 9-12. The example user interface includes a graph area 1000, a well data input area 1040, a tool string data input area 1060, a conveyance equipment (e.g., wireline) input area 1080. The graph area 1000 may comprise or otherwise be indicative of conveyance operational output data (e.g., the determined conveyance operational output data 732) indicative of operational parameters at which the planned conveyance operations are determined to be performed by the determined conveyance equipment indicated in the conveyance equipment output data. The well data input area 1040 may be used to input at least some planned well input data (e.g., the planned well input data 726), the tool string data input area 1060 may be used to input at least some planned tool string input data (e.g., the planned tool string input data 724), and the conveyance equipment input area 1080 may be used to input at least some conveyance equipment input data (e.g., the conveyance equipment input data 724) and/or planned conveyance operational input data (e.g., the planned conveyance operational input data 728).

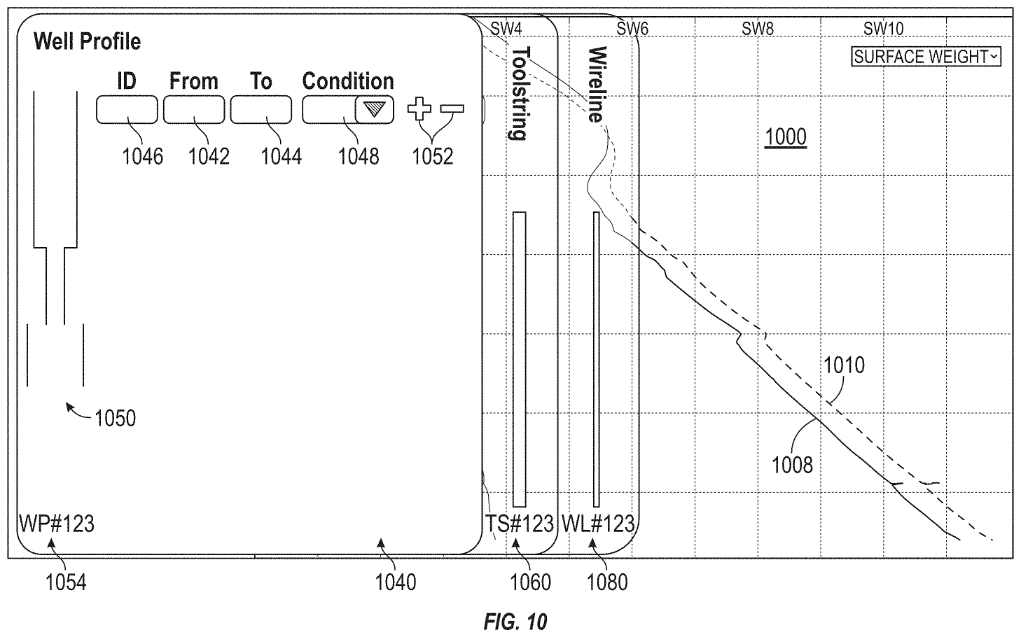

FIG. 9 depicts the input areas 1040, 1060, 1080 as being collapsed, and each input area may be expanded by clicking, touching, or otherwise selecting the desired area. For example, FIG. 10 depicts the well input area 1040 after expansion so that the user may enter text defining axial sections of the well, such as between a “From” depth field 1042 and a “To” depth field 1044, as well as an inner diameter of each axial section in an “ID” field 1046. The well inputs may also include a “Condition” pop-down menu 1048 to select one of a predetermined list of conditions (e.g., new, good, average, issues, bad, open-hole, etc.) of the well in each axial section, and perhaps a medium pop-down menu (not shown) to select one of a predetermined list of mediums/fluids substantially filling each axial section. The well input area 1040 may also include a graphic 1050 schematically depicting the well profile, and perhaps text input fields (not shown) at the top and/or bottom of the well graphic for pressure and/or temperature inputs. A well profile identifier 1054 may also be displayed in the well input area 1040. The profile graphic 1050 and identifier 1054 may remain visible with the well input area 1040 is collapsed, as depicted in FIG. 9. The pop-down menus may include or be associated with explanatory help pop-ups, and may relate to a coefficient matrix cross referenced against the medium selection, such as in the following table.

| RIH | New |
|---|---|
| Gas | 0.25 |
| Oil | 0.15 |

Plus/minus signs and/or other selectable icons 1052 may be utilized to add/delete well sections. When adding a section, the previous section's selections may be recalled and presented, such as may minimize entries needed to complete the well profile.

Where open-hole is selected over certain depths, a sub-list (not shown) may appear to permit the user to enter multiple reservoir zones and their pressures. This information may be used to determine a differential sticking force from the differential pressure of the hydrostatic pressure at the middle point of that zone.

Well survey importation may be a standard “browse for file” action, perhaps with added functionality to scan a selected document. This may permit the model to find columns of data for MD, Inc, and Azi, and populate a hidden deviation survey table.

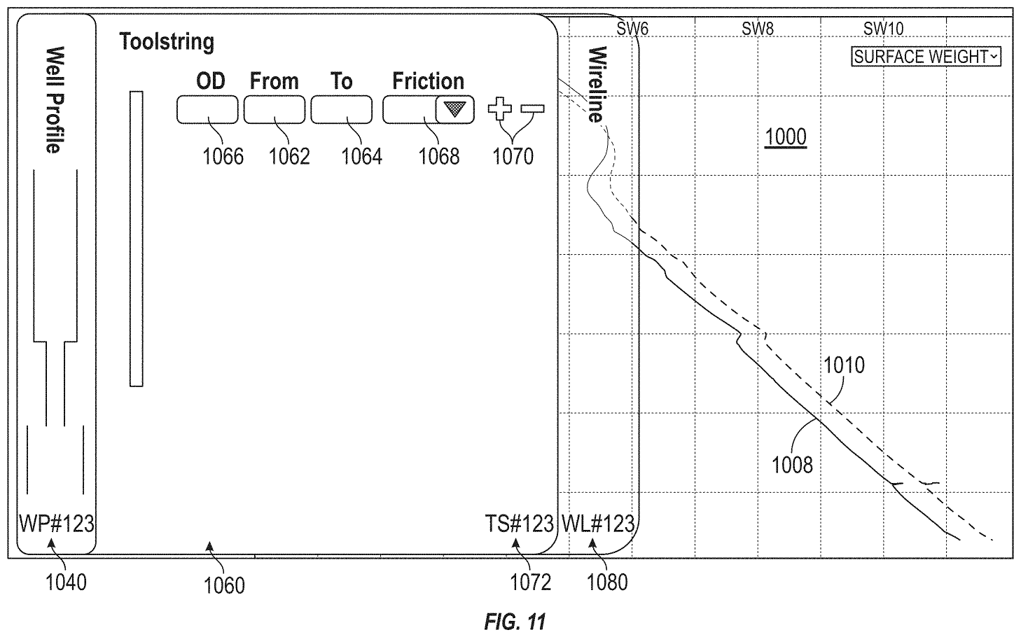

FIG. 11 depicts the tool string area 1060 after expansion so that the user may enter text defining axial sections of the tool string, such as between a “From” depth field 1062 and a “To” depth field 1064, as well as an outer diameter of each axial section in an “OD” field 1066. The tool string data may also include a weight text box (not shown) and a friction drop-down menu 1068 for each tool string section. The friction drop-down menu 1068 may permit selecting from a list of predetermined friction factors, such as friction reduction factors ranging from 10% to 100% in 10% intervals, among other examples. Where the ID of the section above and below one section are both greater, the friction factor may be automatically set to 10% (or some other maximum friction reduction status) for the smaller section, but this may also be overwritten by the user. This feature could be expanded to automate the friction reduction at any level and/or for all tools, and may be based on data from previous operations and/or testing, such as physical sag testing of different lengths, ODs, tool types, and connection types between larger tools of varying sizes. This automation may also add intermediary calculations and/or results as described elsewhere herein.

Plus/minus signs and/or other selectable icons 1070 may be utilized to add/delete tool string sections. When adding a section, the previous section's selections may be recalled and presented, such as may minimize entries needed to complete the tool string profile. A tool string identifier 1072 may also be displayed in the tool string input area 1060.

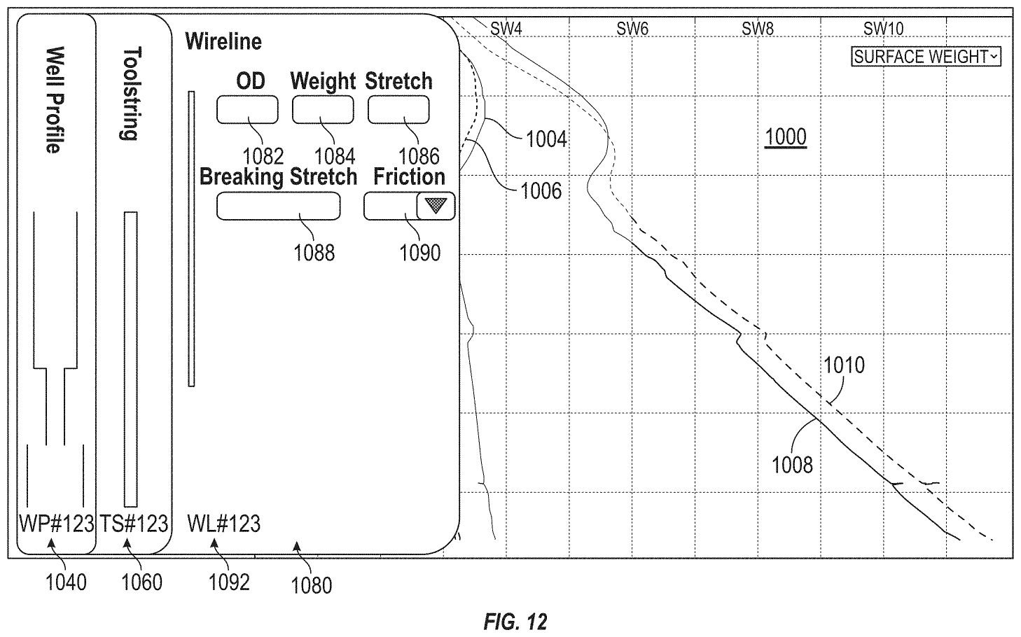

FIG. 12 depicts the conveyance equipment (e.g., wireline) input area 1080 after expansion so that the user may enter text in an OD field 1082, a weight field 1084, a stretch field 1086, a breaking strength field 1088, and a friction reduction drop-down menu 1090. The wireline input area 1080 also includes a wireline identifier 1092.

Although not shown in FIG. 12, the conveyance equipment input area 1080 may include a check box or some other way of indicating that a particular tool string section is or includes conveyance equipment operable to convey the tool string within the well, including one or more of a conveyance means, a jarring tool, a tractor, a roller device, a standoff, a centralizer, and/or other conveyance assisting devices. Such indications may be utilized to inform the model to conduct additional calculations related to such devices, for display in the results. However, as described above, the conveyance equipment for conveying the tool string within the well may be automatically determined (or selected) by a conveyance model from or otherwise based on a listing (or database) of available conveyance equipment. Thus, conveyance equipment output data (e.g., the conveyance equipment output data 742) indicative of conveyance equipment and associated operational parameters determined to be used to perform the planned conveyance operations may be automatically displayed in the conveyance equipment input area 1080 to be viewed by the user. If several optional (or alternative) combinations (or sets) of the available conveyance equipment are determined and presented for viewing, the user may select a combination of the available conveyance equipment based on predetermined considerations or parameters.

The well profile identifier 1054, the tool string identifier 1072, and/or the wireline identifier 1092 may be utilized to look up corresponding sets of inputs in associated libraries. Such means may also minimize input entry time.

If one of the input areas 1040, 1060, 1080 is expanded, and other of the input areas is selected for expansion, the currently expanded input area may automatically be collapsed. Selecting an expanded input area may collapse that input area. The graph area 1000 may remain present regardless of whether any of the input areas 1040, 1060, 1080 are expanded, and may be updated after each data entry is made or modified. Thus, the graph area 1000 may be visible while building and/or optimizing the project. The displayed graph can be changed between surface weight and cable head tension (if not also others) using a drop-down menu, a toggle, a slider, a button, and/or other selection means.

In the example depicted in FIGS. 9-12, the graph area 1000 is displaying surface weight versus depth. The curves include a curve 1002 depicting an initial set of inputs, a curve 1004 depicting a first modification of the inputs, and a curve 1006 depicting a second modification of the inputs. Another curve 1008 represents stretch for RIH, while curve 1010 represents stretch for POOH. Another curve 1012 represents jarring tool firing force.

The output may be iterative, in that the user may adjust inputs to see changes in the results. Results may be automatically attached to the graph in their position until the user selects and deletes, so that a comparison can be seen between two options (e.g., different conveyance equipment). As inputs are changed and new results are added, the curve depicting the previous results line may change, such as in color, thickness, solid-dashed-dotted, etc.

When a tractor is indicated in the tool string, the force required to reach depth may automatically be determined, and that force may be applied to a predetermined length of the well for RIH, such as from 30 meters before the holdup depth to TD. When a jarring tool is indicated in the tool string, optimum settings for the jarring tool may automatically be determined (e.g., based on spreadsheet calculation or otherwise) using inputs already available in the simulation, and the firing line may be automatically displayed on the surface weight graph, perhaps with +/−tolerances determined previously, by the model, and/or otherwise.

TD may be assumed to be the end of the well. If the tool string cannot reach the end of the well, TD may be automatically adjusted to hold-up depth, but may be reset anytime an input is changed.

Outputs may be screenshots of the results, perhaps with minimized inputs visible for reference, such as depicted in FIGS. 9-12.

User inputs and selections from menus may be saved in a database for later retrieval and re-running of simulations. If the product is web-based, usernames (e.g., email) and/or passwords may be utilized for access and record-keeping purposes, as well as for personal or public library purposes. Each project may be saved in a common database against that username/password, and all users may be able to access all projects, well profiles, tool string profiles, and conveyance means profiles added by other users, perhaps referenced by project name and/or creator ID.

Given the above database functionality, a log-in screen will be used as a precursor to the user interface. After providing an approved username and/or password, the user may be asked to enter a name of their new project, or to select an existing project to retrieve from the database. If a previous project is selected and modified, the user may be asked to save or save-as upon closing the project.

Implementations of the above example may also support multiphase scenarios, more or fully automated analysis, and/or other options not explicitly described above.

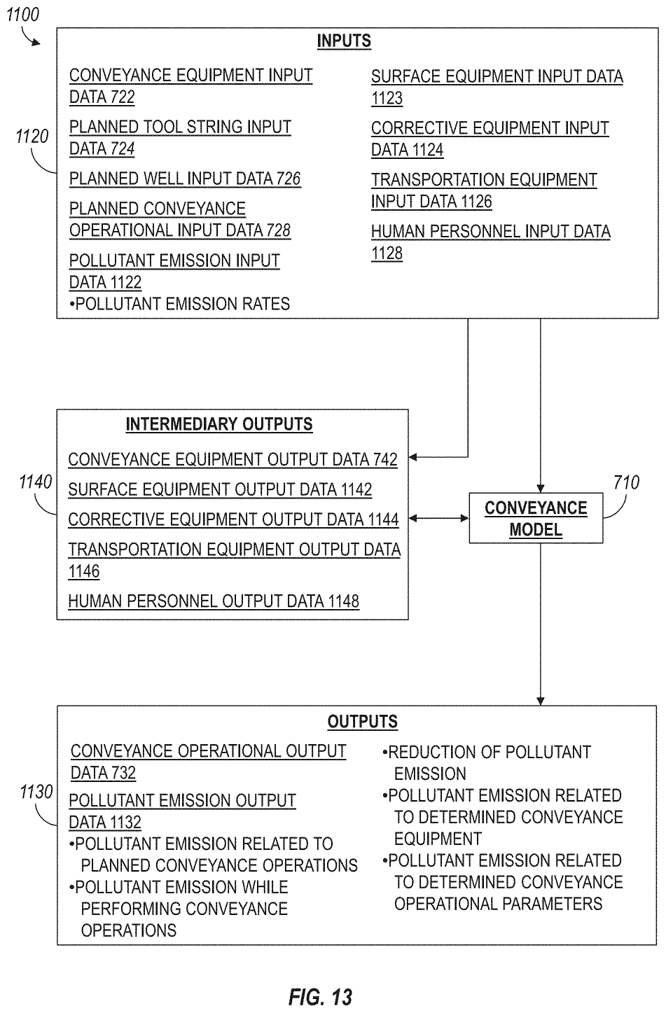

FIG. 13 is a schematic diagram of at least a portion of an example implementation of a conveyance job analysis engine 1100 according to one or more aspects of the present disclosure. The engine 1100 may comprise one or more features and/or modes of operation of the engine 700 shown in FIG. 6, including where indicated by the same reference numerals. The engine 1100 may comprise one or more features and/or modes of operation of the processing system 900 shown in FIG. 8.

The engine 1100 may comprise a job conveyance model 710 operable to determine outputs 1130 and intermediary outputs 1140 based on inputs 1120 indicative of or otherwise related to planned conveyance operations of a tool string within a well based on data indicative of the planned conveyance operations. In an example implementation of the engine 1100, the inputs 1120 may include one or more of: the conveyance equipment input data 722; the planned tool string input data 724; the planned well input data 726; and the planned conveyance operational input data 728. The intermediary outputs 1140 may comprise the conveyance equipment output data 742 and the outputs 1130 may comprise the conveyance operational output data 732 indicative of operational parameters at which the planned conveyance operations are determined to be performed. The engine 1100 may calculate, select, and/or otherwise determine the outputs 1130 based on the intermediary outputs 1140 and the inputs 1120. The engine 1100 may determine some of the outputs 1130, at least in part, based on other outputs 1130. The outputs 1130, 1140 may be determined via the conveyance model 710, other part of the conveyance analysis engine 1100, human personnel, and/or otherwise.

The engine 1100 may also or instead be operable to determine a quantity of emission (e.g., generation, output, etc.) of pollutants (“pollutant emission”) related to the planned downhole conveyance operations. For example, the engine 1100 may be further operable to calculate, predict, or otherwise determine outputs 1130 comprising pollutant emission output data 1132 indicative of a quantity of pollutant emission related to the planned conveyance operations of the tool string within the well based on the inputs 1120, the intermediate outputs 1140, and/or the conveyance operational output data 732. The pollutant emission related to the planned conveyance operations may include pollutants emitted during combustion of fossil fuels, and may include, for example, CO, CO₂, SO₂, NO₂, N₂O, NH₃, various hydrocarbons, such as C₂H₂, C₂H₄, C₃H₆, and CH₄, and particulate material, such as carbon soot. The pollutant emission related to the planned conveyance operations may instead include only GHGs emitted during combustion of fossil fuels, such as CO₂, CH₄, and N₂O.

The inputs 1120 may further comprise pollutant emission input data 1122 indicative of a quantity of pollutant emission related to various equipment, including each instance of the conveyance equipment indicated in the conveyance equipment input data 722. The conveyance equipment input data 722 may be indicative of various conveyance equipment, including conveyance equipment that is capable or otherwise operable to perform the planned conveyance operations. The conveyance equipment output data 742 may be indicative of conveyance equipment determined (or selected) by the conveyance model 710 to be used to perform the planned conveyance operations as well as certain operational parameters of the determined conveyance equipment. Therefore, the pollutant emission output data 1132 may be indicative of a quantity of pollutant emission related to the planned conveyance operations of the tool string within the well based on the pollutant emission input data 1122 and one or more of the determined conveyance equipment indicated in the conveyance equipment output data 742.

For example, the pollutant emission output data 1132 may be indicative of a determined quantity of pollutants that will be emitted or is predicted to be emitted while facilitating the planned conveyance operations. The determined quantity of pollutant emission may be based on the pollutant emission input data 1122, including data indicative of quantity of pollutant emission related to (or associated with) the use of the conveyance equipment indicated in the conveyance equipment input data 722. The determined quantity of pollutant emission may be based further on the planned conveyance operations: while being performed by using the determined conveyance equipment indicated in the conveyance equipment output data 742; and/or while being performed at the determined operational parameters indicated in the conveyance operational output data 732. Thus, the determined quantity of pollutant emission while facilitating the planned conveyance operations may be determined based on the pollutant emission input data 1122 and on one or more of the conveyance equipment output data 742 and/or the conveyance operational output data 732. For example, the conveyance model 710 may receive the conveyance equipment output data 742 and/or the conveyance operational output data 732 and the pollutant emission input data 1122 for or otherwise associated with the determined conveyance equipment indicated in the conveyance equipment output data 742, and determine the quantity of pollutant emission based on such received data.

The conveyance equipment input data 722 (including the conveyance equipment output data 742 for the conveyance equipment determined by the conveyance model 710) may comprise various operational data (e.g., operational specifications) related to the conveyance equipment indicated (e.g., listed) therein. For example, the conveyance equipment input data 722 may comprise durations of time for performing conveyance operations using the conveyance equipment indicated in the conveyance equipment input data 722. Such conveyance equipment input data 722 may include one or more of: a duration of time for performing the planned conveyance operations while being performed by using the conveyance equipment indicated in the conveyance equipment output data 742; and a duration of time for performing the planned conveyance operations while being performed at the operational parameters indicated in the conveyance operational output data 732.

The pollutant emission input data 1122 may be indicative of a rate of pollutant emission for each instance of the conveyance equipment indicated in the conveyance equipment input data 722 and, thus, the determined conveyance equipment indicated in the conveyance equipment output data 742. The conveyance model 710 and/or other portion of the engine 1100 may determine the pollutant emission output data 1132 indicative of the quantity of pollutant emission related to the planned conveyance operations by multiplying the duration of time for performing the planned conveyance operations while being performed by using the conveyance equipment indicated in the conveyance equipment output data 742 and/or the duration of time for performing the planned conveyance operations while being performed at the operational parameters indicated in the conveyance operational output data 732 by the rate of pollutant emission indicated in the pollutant emission input data 1122 for each instance of the conveyance equipment indicated in the conveyance equipment output data 742.

The determined quantity of pollutant emission related to the planned conveyance operations, including while facilitating the planned conveyance operations, may be based further on other inputs 1100 and other intermediary outputs 1140 indicative of other equipment that may be used to facilitate the planned conveyance operations. Such other inputs 1100 may comprise surface equipment input data 1123 indicative of characteristics of surface equipment (e.g., a cable winch, a coiled tubing injector, combustion engine electric generators, combustion engine pump units, electric motor pump units, etc.) that is operable (or that can be used) to perform or otherwise facilitate conveyance operations in addition to the conveyance equipment listed in the conveyance equipment input data 722. The conveyance model 710 and/or other portion of the engine 1100 may then determine (or select) which of the surface equipment indicated in the surface equipment input data 1123 is used with or otherwise in association with the determined conveyance equipment indicated in the conveyance equipment output data 742 and indicate such determined surface equipment in the surface equipment output data 1142. Thus, the other intermediary outputs 1140 may comprise the surface equipment output data 1142 indicative of the surface equipment used with or otherwise in association with the determined conveyance equipment indicated in the conveyance equipment output data 742. The surface equipment input data 1123 and, thus, the surface equipment output data 1142, may include a duration of time for using each instance of the surface equipment when performing or otherwise facilitating corresponding conveyance operations performed by using the conveyance equipment indicated in the conveyance equipment input data 722. The surface equipment output data 1142 may include one or more of: duration of time for using each instance of the surface equipment for performing the planned conveyance operations performed by using the conveyance equipment indicated in the conveyance equipment output data 742 and/or the duration of time for using each instance of the surface equipment for performing the planned conveyance operations while being performed at the operational parameters indicated in the conveyance operational output data 732.

The pollutant emission input data 1122 may be indicative of a rate of pollutant emission for each instance of the surface equipment indicated in the surface equipment input data 1123 and, thus, each instance of the surface equipment indicated in the determined surface equipment output data 1142. The conveyance model 710 and/or other portion of the engine 1100 may then determine the pollutant emission output data 1132 indicative of the quantity of pollutant emission related to the determined surface equipment and the planned conveyance operations by multiplying the duration of time for using the determined surface equipment indicated in the surface equipment output data 1142 by the rate of pollutant emission indicated in the pollutant emission input data 1122 for each instance of the surface equipment indicated in the surface equipment output data 1142. The determined quantity of pollutant emission related to the use of the surface equipment may be added to the determined quantity of pollutant emission related to the use of the conveyance equipment to determine the total quantity of pollutant emission related to the planned conveyance operations.

The determined quantity of pollutant emission related to the planned conveyance operations, including while facilitating the planned conveyance operations, may be based further on other inputs 1100 and other intermediary outputs 1140 indicative of other equipment that may be used to facilitate the planned conveyance operations. Such other inputs 1100 may comprise corrective equipment input data 1124 indicative of characteristics (e.g., speed, power, etc.) of corrective equipment (e.g., fishing equipment, impact jars, surface tensioning tools, etc.) that can be used to perform corrective operations that may be performed when problems occur during or as a result of the conveyance operations. Problems may include, for example, the tool string becoming stuck within the well and the tool string not being able to reach an intended depth, resulting in the conveyance operations being performed again. The conveyance model 710 and/or other portion of the engine 1100 may then determine (or select) which of the corrective equipment indicated in the corrective equipment input data 1124 is to be used with or otherwise in association with the determined conveyance equipment indicated in the conveyance equipment output data 742 and indicate such determined corrective equipment in the corrective equipment output data 1144. Thus, the other intermediary outputs 1140 may comprise the corrective equipment output data 1144 indicative of the corrective equipment used with or otherwise in association with the determined conveyance equipment indicated in the conveyance equipment output data 742. The corrective equipment input data 1124 and, thus, the corrective equipment output data 1144, may include an expected duration of time for using each instance of the corrective equipment when performing or otherwise facilitating corresponding conveyance operations by using the conveyance equipment indicated in the conveyance equipment input data 722. The expected duration of time for using each instance of the corrective equipment may be calculated based on statistical likelihood of a problem occurring during or as a result of various conveyance operations being performed by various conveyance equipment and at various operational parameters. The corrective equipment output data 1144 may include one or more of: a duration of time for performing downhole corrective operations resulting from the planned conveyance operations while being performed by using the conveyance equipment indicated in the conveyance equipment output data 742; and a duration of time for performing downhole corrective operations resulting from the planned conveyance operations while being performed at the operational parameters indicated in the conveyance operational output data 732.

The pollutant emission input data 1122 may be indicative of a rate of pollutant emission for each instance of the corrective equipment indicated in the corrective equipment input data 1124 and, thus, each instance of the corrective equipment indicated in the determined corrective equipment output data 1144. The conveyance model 710 and/or other portion of the engine 1100 may then determine the pollutant emission output data 1132 indicative of the quantity of pollutant emission related to the determined corrective equipment and the planned conveyance operations by multiplying the duration of time for using the determined corrective equipment indicated in the corrective equipment output data 1144 by the rate of pollutant emission indicated in the pollutant emission input data 1122 for each instance of the corrective equipment indicated in the corrective equipment output data 1144. The determined quantity of pollutant emission related to the use of the corrective equipment may be added to the determined quantity of pollutant emission related to the use of the conveyance equipment and the surface equipment to determine the total quantity of pollutant emission related to the planned conveyance operations.

The determined quantity of pollutant emission related to the planned conveyance operations, including while facilitating the planned conveyance operations, may be based further on other inputs 1100 and other intermediary outputs 1140 indicative of other equipment that may be used to facilitate the planned conveyance operations. Such other inputs 1100 may comprise transportation equipment input data 1126 indicative of characteristics (e.g., speed, capacity, etc.) of transportation equipment (e.g., boats, planes, helicopters, trains, trucks, etc.) that can be used to transport various equipment (e.g., the conveyance equipment, the corrective equipment, etc.) and human personnel to the wellsite at which the well is located. The conveyance model 710 and/or other portion of the engine 1100 may then determine (or select) which of the transportation equipment indicated in the transportation equipment input data 1126 is to be used with or otherwise in association with the determined conveyance equipment indicated in the conveyance equipment output data 742, the determined surface equipment indicated in the surface equipment output data 1142, and/or the determined corrective equipment indicated in the corrective equipment output data 1144, and then indicate such determined transportation equipment in the transportation equipment output data 1146. Thus, the other intermediary outputs 1140 may comprise the transportation equipment output data 1146 indicative of the transportation equipment used with or otherwise in association with the determined equipment indicated in the equipment output data 742, 1142, 1144. The transportation equipment output data 1146 may include a determined (or expected) duration of time for using each instance of the transportation equipment when performing or otherwise facilitating transportation operations to the wellsite at which the well is located. The determined duration of time indicated in the transportation equipment output data 1146 may be based on a distance between a location at which the determined equipment is located and the wellsite at which the well is located. The determined duration of time indicated in the transportation equipment output data 1146 may thus be based on the planned well input data 726, which may be indicative of the location of the wellsite at which the well is located. The transportation equipment output data 1146 may include one or more of: a duration of time for transporting the conveyance equipment indicated in the conveyance equipment output data 742 to the wellsite at which the well is located; a duration of time for transporting the surface equipment indicated in the surface equipment output data 1142 to the wellsite at which the well is located; and a duration of time for transporting the corrective equipment indicated in the corrective equipment output data 1144 to the wellsite at which the well is located.

The pollutant emission input data 1122 may be indicative of a rate of pollutant emission for each instance of the transportation equipment indicated in the transportation equipment input data 1126 and, thus, each instance of the transportation equipment indicated in the determined transportation equipment output data 1146. The conveyance model 710 and/or other portion of the engine 1100 may then determine the pollutant emission output data 1132 indicative of the quantity of pollutant emission related to the determined transportation equipment and the planned conveyance operations by multiplying the duration of time for using the determined transportation equipment indicated in the transportation equipment output data 1146 by the rate of pollutant emission indicated in the pollutant emission input data 1122 for each instance of the transportation equipment indicated in the transportation equipment output data 1146. The determined quantity of pollutant emission related to the use of the transportation equipment may be added to the determined quantity of pollutant emission related to the use of the conveyance equipment, the surface equipment, and the corrective equipment to determine the total quantity of pollutant emission related to the planned conveyance operations.

The determined quantity of pollutant emission related to the planned conveyance operations, including while facilitating the planned conveyance operations, may be based further on other inputs 1100 and other intermediary outputs 1140 indicative of human personnel that may be used to perform or otherwise facilitate the planned conveyance operations. Such other inputs 1100 may therefore comprise human personnel input data 1128 indicative of quantities of human personnel (e.g., rig personnel, equipment operators, etc.) used to perform the conveyance operations, perform other operations to facilitate the planned conveyance operations, and/or to perform other operations resulting from (or necessitated by) the performance of the planned conveyance operations. The conveyance model 710 and/or other portion of the engine 1100 may then determine (or select) which and/or the quantity of human personnel indicated in the human personnel input data 1128 is used to operate or otherwise in association with the determined conveyance equipment indicated in the conveyance equipment output data 742, the determined surface equipment indicated in the surface equipment output data 1142, the determined corrective equipment indicated in the corrective equipment output data 1144, and/or the determined transportation equipment indicated in the corrective equipment output data 1146, and then indicate the determined data indicative of which and/or the quantity of human personnel in the human personnel output data 1148. Thus, the other intermediary outputs 1140 may comprise the human personnel output data 1148 indicative of which and/or the quantity of human personnel to be used to operate or otherwise in association with: the determined conveyance equipment indicated in the conveyance equipment output data 742; the determined surface equipment indicated in the surface equipment output data 1142; the determined corrective equipment indicated in the corrective equipment output data 1144; and the determined transportation equipment indicated in the transportation equipment output data 1146.

The pollutant emission input data 1122 may be indicative of a rate of pollutant emission for each human personnel indicated in the human personnel input data 1128 and, thus, each human personnel indicated in the human personnel output data 1148. The conveyance model 710 and/or other portion of the engine 1100 may then determine the pollutant emission output data 1132 indicative of the quantity of pollutant emission related to the determined human personnel and the planned conveyance operations by multiplying the quantity of human personnel indicated in the human personnel output data 1148 by the rate of pollutant emission indicated in the pollutant emission input data 1122. The determined quantity of pollutant emission related to the human personnel may be added to the determined quantity of pollutant emission related to the use of the conveyance equipment, the surface equipment, the corrective equipment, and the transportation equipment to determine the total quantity of pollutant emission related to the planned conveyance operations.

As described above, the engine 1100 may be operable to generate intermediary outputs 1140 comprising conveyance equipment output data 742 indicative of conveyance equipment to be used to perform the planned conveyance operations based on inputs 1120 indicative of planned conveyance operations of a tool string within a well. The inputs 1120 may include one or more of: conveyance equipment input data 722 indicative of conveyance equipment operable to perform the planned conveyance operations; planned tool string input data 724 indicative of the tool string that is planned to be conveyed within the well during the planned conveyance operations; planned well input data 726 indicative of the well within which the tool string is planned to be conveyed during the planned conveyance operations and the planned conveyance operational input data 728 indicative of planned operational parameters at which the planned conveyance operations are planned to be performed.

The engine 1100 may be further operable to generate intermediary outputs 1140 comprising conveyance equipment output data 742 indicative of a plurality of different sets (or combinations) of conveyance equipment, each set being operable to perform the planned conveyance operations based on inputs 1120 indicative of planned conveyance operations of a tool string within a well. Each set of conveyance equipment may be or comprise one or more instances (or combinations) of different conveyance equipment collectively operable to perform the planned conveyance operations. Each set of the conveyance equipment may be or comprise an alternative (or optional) set of conveyance equipment operable to perform the planned conveyance operations.

The engine 1100 may be further operable to determine outputs 1130 comprising pollutant emission output data 1132 indicative of a quantity of pollutant emission related to the planned conveyance operations based on the inputs 1120 and the intermediary outputs 1140 for each set of the determined conveyance equipment. For example, the engine 1100 may determine intermediary outputs 1140 comprising conveyance equipment output data 742 indicative of: a first set of conveyance equipment operable to perform the planned conveyance operations; a second set of conveyance equipment operable to perform the planned conveyance operations; and a third set of conveyance equipment operable to perform the planned conveyance operations. The engine 1100 may further determine outputs 1130 comprising pollutant emission output data 1132 that is indicative of: a first quantity of pollutant emission related to the planned conveyance operations while being performed by using the first set of conveyance equipment; a second quantity of pollutant emission related to the planned conveyance operations while being performed by using the second set of conveyance equipment; and a third quantity of pollutant emission related to the planned conveyance operations while being performed by using the third set of conveyance equipment. Thus, similarly as described above, for each set of the determined conveyance equipment indicated in the conveyance equipment output data 742, the engine 1100 may determine the surface equipment output data 1142, the corrective equipment output data 1144, the transportation equipment output data 1146, and the human personnel output data 1148. The engine 1100 may further determine a quantity of pollutant emission related to each of the determined output data 742, 1142, 1144, 1146, 1148 based on a rate of pollutant emission indicated in the pollutant emission input data 1122. The engine 1100 may further determine a total quantity of pollutant emission related to the planned conveyance operations for each set of the determined conveyance equipment.

The engine 1100 may further determine outputs 1130 comprising pollutant emission output data 1132 indicative of a reduction of a quantity of pollutants that will (or is expected to) be emitted while facilitating the planned conveyance operations. Such reduction of a quantity of pollutant emission may be determined by determining a baseline (or a first) quantity of pollutant emission generated while facilitating the planned conveyance operations, determining a reduced (or a second) quantity of pollutant emission generated while facilitating the planned conveyance operations, and then comparing (or determining a difference between) the baseline quantity of pollutant emission and the reduced quantity of pollutant emission to therefore determine the reduction of the quantity of pollutant emission.

The reduced quantity of pollutant emission may be or comprise a quantity of pollutant emission related to the planned conveyance operations determined by the engine 1100 based on one or more of the inputs 1120, the intermediary outputs 1140, and the conveyance operational output data 732, as described above. The various equipment and human personnel data indicated in the intermediary outputs 1140 and the operational parameter data indicated in the conveyance operational output data 732 may be or comprise optimal data indicative of equipment, operational parameters, quantities, and other constraints determined by the engine 1100 to cause the lowest or otherwise reduced amount of pollutant emission.

The reduced quantity of pollutant emission may be or comprise a quantity of pollutant emission that is projected to be generated (or emitted) based on the pollutant emission input data 1122 while performing the planned conveyance operations by using conveyance equipment indicated in the determined conveyance equipment output data 742 and/or while performing the planned conveyance operations at the operational parameters indicated in the determined conveyance operational output data 732. The reduced quantity of pollutant emission may further be or comprise a quantity of pollutant emission related to the planned conveyance operations as determined based on the pollutant emission input data 1122 and one or more of the determined surface equipment output data 1142, the determined corrective equipment output data 1144, the determined transportation equipment output data 1146, and the determined human personnel output data 1148.

The reduced quantity of pollutant emission may be or comprise a quantity of pollutant emission that is projected to be generated while performing the planned conveyance operations by using the conveyance equipment indicated in the determined conveyance equipment output data 742 and/or while performing the planned conveyance operations at the operational parameters indicated in the determined conveyance operational output data 732. The reduced quantity of pollutant emission may also or instead be or comprise a quantity of pollutant emission that is projected to be generated while performing corrective operations resulting from the planned conveyance operations that have been performed by using the conveyance equipment indicated in the conveyance equipment output data 742 and/or while performing corrective operations resulting from the planned conveyance operations that have been performed at the operational parameters indicated in the conveyance operational output data 732. The reduced quantity of pollutant emission may also or instead be or comprise a quantity of pollutant emission that is projected to be generated while performing transportation operations resulting from the planned conveyance operations being performed by using the conveyance equipment indicated in the conveyance equipment output data 742 and/or while performing transportation operations resulting from the planned conveyance operations being performed at the operational parameters indicated in the conveyance operational output data 732.

The reduced quantity of pollutant emission may be or comprise a quantity of pollutant emission that is projected to be generated based on rates of pollutant emission indicated in the pollutant emission input data 1122: while performing the planned conveyance operations using conveyance equipment and/or for a duration of time indicated in the determined conveyance equipment output data 742; while performing the planned conveyance operations at operational parameters and/or for a duration of time indicated in the determined conveyance operational output data 732; while performing the surface operations by using the surface equipment and/or for a duration of time indicated in the determined surface equipment operational output data 1142; while performing the corrective operations by using the corrective equipment and/or for a duration of time indicated in the determined corrective equipment operational output data 1144; while performing the transportation operations by using the transportation equipment, for a duration (i.e., span or period) of time, and/or for a distance indicated in the determined transportation equipment operational output data 1146; and/or by using the quantity of human personnel indicated in the determined human personnel output data 1148. The reduced quantity of pollutant emission indicated in the pollutant emission output data 1132 may thus be based on one or more of: a duration of time for performing the planned conveyance operations while being performed by using the determined conveyance equipment indicated in the conveyance equipment output data 742; a duration of time for performing the planned conveyance operations while being performed at the determined operational parameters indicated in the conveyance operational output data 732; a duration of time for performing the determined downhole corrective operations resulting from the planned conveyance operations while being performed by using the conveyance equipment indicated in the conveyance equipment output data 742; a duration of time for performing the downhole corrective operations resulting from the planned conveyance operations while being performed at the operational parameters indicated in the conveyance operational output data 732; a duration of time for transporting the conveyance equipment indicated in the conveyance equipment output data 742 to a wellsite at which the well is located; a duration of time for transporting the corrective equipment indicated in the corrective equipment output data 1144 to the wellsite at which the well is located; a quantity (or a number) of wellsite personnel used for operating the conveyance equipment indicated in the conveyance equipment output data 742; a quantity of wellsite personnel used for operating the surface equipment indicated in the surface equipment output data 1142; a quantity of wellsite personnel used for operating the corrective equipment indicated in the corrective equipment output data 1144; a quantity of wellsite personnel used for operating the transportation equipment indicated in the transportation equipment output data 1146; a rate of pollutant emission of the conveyance equipment indicated in the conveyance equipment output data 742; a rate of pollutant emission of surface equipment indicated in the surface equipment output data 1142 at the wellsite at which the well is located; a rate of pollutant emission to transport the conveyance equipment indicated in the conveyance equipment output data 742 to the wellsite at which the well is located; a rate of pollutant emission to transport the corrective equipment indicated in the corrective equipment output data 1144 to the wellsite at which the well is located; and a rate of pollutant emission of an instance of the wellsite personnel indicated in the human personnel output data 1148.

The baseline quantity of pollutant emission may be or comprise a quantity of pollutant emission related to the planned conveyance operations determined based on the inputs 1120 and/or other inputs, but not the intermediary outputs 1140 or the conveyance operational output data 732. The baseline quantity of pollutant emission may therefore be or comprise a quantity of pollutant emission that is not reduced or otherwise optimized. The baseline quantity of pollutant emission may thus be or comprise a typical (e.g., an average) or otherwise less-than-optimal quantity of pollutant emission generated using equipment, operational parameters, and/or quantities of human personnel that are typically used in the oil and gas industry to facilitate downhole conveyance operations.

For example, the baseline quantity of pollutant emission may be or comprise a quantity of pollutant emission that is projected to be generated (or emitted) based on the pollutant emission input data 1122 or other inputs 1120 while performing the planned conveyance operations by using conveyance equipment not indicated in the determined conveyance equipment output data 742 and/or while performing the planned conveyance operations at operational parameters not indicated in the determined conveyance operational output data 732. The baseline quantity of pollutant emission may further be or comprise a quantity of pollutant emission related to the planned conveyance operations as determined based on the pollutant emission input data 1122 and/or other inputs 1120, but not based on one or more of the determined surface equipment output data 1142, the determined corrective equipment output data 1144, the determined transportation equipment output data 1146, and the determined human personnel output data 1148.

The baseline quantity of pollutant emission may be or comprise a quantity of pollutant emission that is projected to be generated while performing the planned conveyance operations by using the conveyance equipment not indicated in the determined conveyance equipment output data 742 and/or while performing the planned conveyance operations at the operational parameters not indicated in the determined conveyance operational output data 732. The baseline quantity of pollutant emission may also or instead be or comprise a quantity of pollutant emission that is projected to be generated while performing surface operations resulting from the planned conveyance operations that have been performed by using the surface equipment not indicated in the surface equipment output data 1142 and/or while performing surface operations resulting from the planned conveyance operations that have been performed at the operational parameters not indicated in the conveyance operational output data 732. The baseline quantity of pollutant emission may also or instead be or comprise a quantity of pollutant emission that is projected to be generated while performing corrective operations resulting from the planned conveyance operations that have been performed by using the conveyance equipment not indicated in the conveyance equipment output data 742 and/or while performing corrective operations resulting from the planned conveyance operations that have been performed at the operational parameters not indicated in the conveyance operational output data 732. The baseline quantity of pollutant emission may also or instead be or comprise a quantity of pollutant emission that is projected to be generated while performing transportation operations resulting from the planned conveyance operations being performed by using the conveyance equipment not indicated in the conveyance equipment output data 742 and/or while performing transportation operations resulting from the planned conveyance operations being performed at the operational parameters not indicated in the conveyance operational output data 732.

The baseline quantity of pollutant emission may be or comprise a quantity of pollutant emission that is projected to be generated based on rates of pollutant emission indicated in the pollutant emission input data 1122 and/or other inputs 1120: while performing the planned conveyance operations using conveyance equipment and for a duration of time not indicated in the determined conveyance equipment output data 742; while performing the planned conveyance operations at operational parameters and for a duration of time not indicated in the determined conveyance operational output data 732; while performing the surface operations by using the surface equipment and for a duration of time not indicated in the determined surface equipment operational output data 1142; while performing the corrective operations by using the corrective equipment and for a duration of time not indicated in the determined corrective equipment operational output data 1144; while performing the transportation operations by using the transportation equipment, for a duration of time, and for a distance not indicated in the determined transportation equipment operational output data 1146; and/or by using the quantity of human personnel not indicated in the determined human personnel output data 1148. The baseline quantity of pollutant emission may therefore be based on one or more of: a duration of time for performing the planned conveyance operations while being performed by using conveyance equipment not indicated in the conveyance equipment output data 742; a duration of time for performing the planned conveyance operations while being performed at operational parameters not indicated in the conveyance operational output data 732; a duration of time for performing the determined downhole corrective operations resulting from the planned conveyance operations while being performed by using the conveyance equipment not indicated in the conveyance equipment output data 742; a duration of time for performing the downhole corrective operations resulting from the planned conveyance operations while being performed at the operational parameters not indicated in the conveyance operational output data 732; a duration of time for performing the determined surface operations resulting from the planned conveyance operations while being performed by using the conveyance equipment not indicated in the conveyance equipment output data 742; a duration of time for performing the surface operations resulting from the planned conveyance operations while being performed at the operational parameters not indicated in the conveyance operational output data 732; a duration of time for transporting the conveyance equipment not indicated in the conveyance equipment output data 742 to a wellsite at which the well is located; a duration of time for transporting the corrective equipment not indicated in the corrective equipment output data 1144 to the wellsite at which the well is located; a quantity of wellsite personnel used for operating the conveyance equipment not indicated in the conveyance equipment output data 742; a quantity of wellsite personnel used for operating the surface equipment not indicated in the surface equipment output data 1142; a quantity of wellsite personnel used for operating the corrective equipment not indicated in the corrective equipment output data 1144; a rate of pollutant emission of the conveyance equipment not indicated in the conveyance equipment output data 742; a rate of pollutant emission of surface equipment not indicated in the surface equipment output data 1142 at the wellsite at which the well is located; a rate of pollutant emission to transport the conveyance equipment not indicated in the conveyance equipment output data 742 to the wellsite at which the well is located; a rate of pollutant emission to transport the corrective equipment not indicated in the corrective equipment output data 1144 to the wellsite at which the well is located; and a rate of pollutant emission of an instance of the wellsite personnel not indicated in the human personnel output data 1148. The engine 1100 may then compare (or determine the difference between) the baseline quantity of pollutant emission and the reduced quantity of pollutant emission to determine the pollutant emission output data 1132 indicative of the reduction of the quantity of pollutant emission.

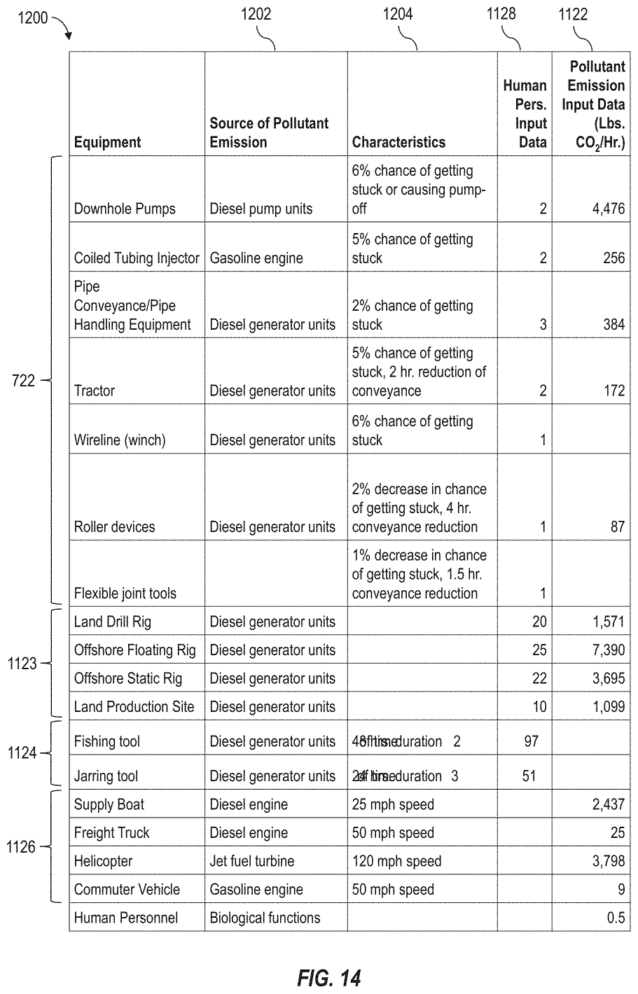

FIG. 14 is a table 1200 listing example inputs 1120 that may be used as a basis for determining outputs 1130, 1140 by the conveyance job analysis engine 1100 shown in FIG. 13 according to one or more aspects of the present disclosure. Accordingly, the following description refers to FIGS. 13 and 14, collectively.

The table 1200 includes example conveyance equipment input data 722 indicative of various devices or systems for facilitating downhole conveyance of a tool string. The table 1200 includes example surface equipment input data 1123 indicative of different types of wellsites (and, thus, indicative of surface equipment) at which the planned conveyance operations may be performed. The table 1200 includes example corrective equipment input data 1124 indicative of corrective equipment that may be used to perform corrective operations. The table 1200 includes example transportation equipment input data 1126 indicative of transportation equipment that may be used to deliver equipment and human personnel to the wellsite. Each of the input data 722, 1123, 1124, 1126 may be indicative of a corresponding pollutant emission source 1202 (e.g., a combustion engine) that supplies mechanical and/or electrical power to each of the listed equipment. For example, some of the listed equipment may be powered by a diesel pump unit, others may be powered by a gasoline engine, and still others may be powered by a diesel engine generator. Each of the input data 722, 1123, 1124, 1126 may be indicative of corresponding structural and/or operational characteristics 1204 (e.g., operational parameters, values, etc.) associated with each of the listed equipment. The table 1200 also includes example human personnel input data 1128 indicative of number of human personnel that may be used to operate each corresponding piece of equipment indicated in the input data 722, 1123, 1124, 1126. The table 1200 also includes example pollutant emission input data 1122 indicative of amount of pollutants produced or caused to be produced per unit of time by human personnel and each corresponding piece of equipment indicated in the input data 722, 1123, 1124, 1126.

Because a vast majority of pollutants generated during combustion of fossil fuels is CO₂ gas, the pollutant emission input data 1122 may be indicative of amount (e.g., pounds) of CO₂ gas produced or caused to be produced per unit of time (e.g., hour) by human personnel and each corresponding piece of equipment indicated in the input data 722, 1123, 1124, 1126. However, it is to be understood that the pollutant emission input data 1122 received by the engine 1100 may include other quantitative units of measure (e.g., kilograms, tons, cubic meters, etc.) and temporal units of measure (e.g., seconds, minutes, days, etc.). It is to be further understood that the pollutant emission input data 1122 received by the engine 1100 may instead include other qualitative (or identifying) units of measure, such as indicative of global warming potential (GWP) of a pollutant. For example, the pollutant emission input data 1122 indicative of a GWP of a pollutant may be expressed in terms of (or as a measure of) carbon dioxide equivalent (“CO₂e”), which is a unit of measure of global warming impact of CO₂ gas. Thus, the pollutant emission input data 1122 comprising CO₂e units of measure is indicative of GWP of different pollutants expressed in terms of GWP of CO₂. Expressing pollutants in terms of their GWP permits comparison of different pollutants in terms of their global warming impact via a single measurement. It is to be still further understood that the pollutant emission input data 1122 received by the engine 1100 may include instead other qualitative units of measure, such as an amount of carbon contained in a pollutant. Such units of measure of carbon may be calculated based on atomic weight of carbon with respect to total atomic weight of the pollutant and then multiplied by mass of the emitted pollutant.

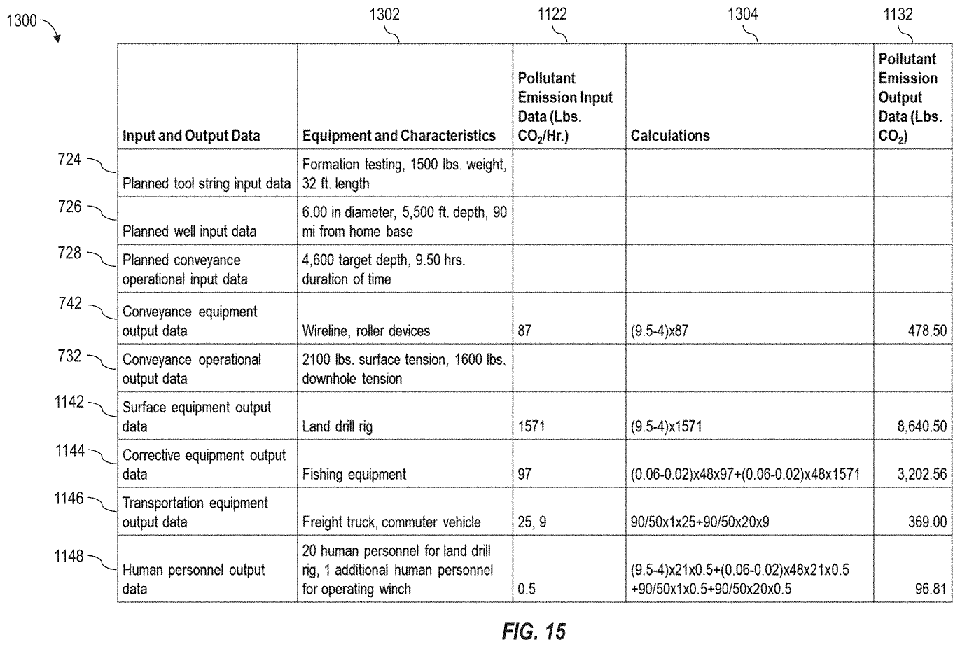

FIG. 15 is a table 1300 listing example data that may be used as a basis for determining pollutant emission output data 1132 by the conveyance job analysis engine 1100 shown in FIG. 13 according to one or more aspects of the present disclosure. The data shown on table 1300 may be determined by the engine 1100 based on, at least in part, the data listed on table 1200 shown in FIG. 14. Accordingly, the following description refers to FIGS. 13-15, collectively.

The table 1300 includes example planned tool string input data 724 indicative of structural and/or operational characteristics (e.g., parameters, values, etc.) of a planned tool string that is planned to perform the planned downhole job. Such characteristics may include type of tool string, weight of the tool string, and length of the tool string. The table 1300 includes example planned well input data 726 indicative of structural and/or operational characteristics of a planned well within which the planned tool string is planned to perform the planned downhole job. Such characteristics may include diameter, depth, and distance from home base (e.g., equipment storage facility, personnel residence, etc.). The table 1300 includes example planned conveyance operational input data 728 indicative of planned operational parameters at which the planned conveyance operations are planned to be performed. Such parameters may include target depth for the planned conveyance operations and planned duration of time for the planned conveyance operations. The table 1300 includes various example intermediate outputs 1140 determined by the engine 1100, including conveyance equipment output data 742, conveyance operational output data 732, surface equipment output data 1142, corrective equipment output data 1144, and transportation equipment output data 1146. The output data 742, 732, 1142, 1144, 1146 may be indicative of equipment 1302 determined by the engine 1100 and corresponding operational characteristics of the equipment. The table 1300 also includes example human personnel output data 1148 indicative of quantity of human personnel to be used to operate each of the determined piece or set of equipment. The table 1300 includes the pollutant emission input data 1122 indicative of rate of pollutant emission (e.g., pounds of CO₂ per hour) produced or caused to be produced by each corresponding piece of equipment and human personnel indicated in the output data 742, 1142, 1144, 1146, 1148.

The table 1300 also includes example pollutant emission output data 1132 determined by the engine 1100 and indicative of a quantity of pollutant emission related to the planned conveyance operations. Similarly to the pollutant emission input data 1122, the pollutant emission output data 1132 determined by the engine 1100 may be indicative of amount (e.g., pounds) of CO₂ gas produced or caused to be produced per unit of time (e.g., an hour). However, it is to be understood that the pollutant emission output data 1132 determined by the engine 1100 may instead include other quantitative units of measure (e.g., kilograms, tons, cubic meters, etc.) and temporal units of measure (e.g., seconds, minutes, days, etc.). It is to be further understood that the pollutant emission output data 1132 determined by the engine 1100 may instead include other qualitative means for measuring pollutant emission, including global warming potential (e.g., CO₂e) of a pollutant or amount of carbon contained in a pollutant.

The table 1300 also includes example calculations 1304 that the engine 1100 may perform based on the data 724, 726, 728, 732, 742, 1122, 1142, 1144, 1146, 1148 to determine the pollutant emission output data 1132. As shown on table 1300, the engine 1100 may determine the quantity of pollutant emission caused by the conveyance operations by calculating a product of the planned duration of time for performing the conveyance operations, which has been reduced by the use of roller devices, and the rate of pollutant emission caused by the conveyance operations. The engine 1100 may determine the quantity of pollutant emission caused by operations of the surface equipment by calculating a product of the planned duration of time for conveyance operations and the rate of pollutant emission caused by the surface equipment. The engine 1100 may determine the quantity of pollutant emission caused by operations of the corrective equipment by calculating a product of expected chance of performing corrective operations, which has been reduced by the use of roller devices, expected duration of time for performing the corrective operations, and the rate of pollutant emission caused by the corrective equipment, calculating a product of expected chance of performing the corrective operations, expected duration of time for performing the corrective operations, and the rate of pollutant emission caused by the surface equipment, and then calculating a sum of the calculated products. The engine may determine the quantity of pollutant emission caused by operations of the transportation equipment by calculating a product of expected amount of time for transporting equipment (e.g., the tool string, the conveyance equipment, the corrective equipment, etc.) to the wellsite, the number of trips to the wellsite, and the rate of pollutant emission caused by the transportation equipment, calculating a product of expected amount of time for transporting each human personnel to the wellsite, the number of trips to (or quantity of human personnel at) the wellsite, and the rate of pollutant emission caused by the transportation equipment, and then calculating a sum of the calculated products. The engine may determine the quantity of pollutant emission caused by human personnel by calculating a product of the planned duration of time for conveyance operations, the quantity of human personnel at the wellsite, and the rate of pollutant emission produced by each human personnel, calculating a product of expected chance of performing corrective operations, expected duration of time for performing the corrective operations, the quantity of human personnel at the wellsite, and the rate of pollutant emission produced by each human personnel, calculating a product of expected amount of time for transporting equipment to the wellsite, the number of trips to the wellsite, and the rate of pollutant emission produced by each human personnel, calculating a product of expected amount of time for transporting each human personnel to the wellsite, the number of trips to the wellsite, and the rate of pollutant emission produced by each human personnel, and then calculating a sum of the calculated products. The engine may then determine the total quantity of pollutant emission caused by the conveyance operations by calculating the sum of the quantity of pollutant emission caused by the conveyance operations, quantity of pollutant emission caused by the operations of the surface equipment, quantity of pollutant emission caused by the corrective operations, quantity of pollutant emission caused by the transportation operations, and quantity of pollutant emission caused by the human personnel.

As described above, the conveyance job analysis engine 1100 according to one or more aspects of the present disclosure may be further operable to determine conveyance equipment output data 742 indicative of a plurality of alternative sets of conveyance equipment based on the same inputs, each alternative set of conveyance equipment comprising one or more instances of different conveyance equipment collectively operable to perform the planned conveyance operations. When the engine 1100 is set to determine conveyance equipment output data 742 indicative a plurality of alternative sets of conveyance equipment, the engine may determine a plurality of alternative sets of conveyance equipment output data 742 and associated conveyance operational output data 732, surface equipment output data 1142, corrective equipment output data 1144, transportation equipment output data 1146, and human personnel output data 1148. The engine may then determine the pollutant emission output data 1132 for each set of conveyance equipment output data 742 in the same or similar manner as described above with respect to table 1300.

As described above, the engine 1100 according to one or more aspects of the present disclosure may also or instead be operable to determine pollutant emission output data 1132 indicative of a reduced quantity of pollutant emission for conveyance equipment output data 742 (and associated output data 732, 1142, 1144, 1146, 1148) indicative of a plurality of alternative sets of conveyance equipment. The engine 1100 may compare each reduced quantity of pollutant emission to a baseline quantity of pollutant emission to determine the pollutant emission output data 1132 indicative of the reduction of the quantity of pollutant emission for each alternative set of conveyance equipment. The pollutant emission output data 1132 determined for a single set of conveyance equipment output data 742 or for a plurality of alternative sets of conveyance equipment output data 742 may be considered as the pollutant emission output data 1132 indicative of a reduced quantity of pollutant emission. The engine 1100 may determine the baseline quantity of pollutant emission by calculating pollutant emission output data 1132 in the same or similar manner as described above with respect to table 1300 for conveyance equipment, conveyance operational parameters, surface equipment, corrective equipment, transportation equipment, and/or quantities of human personnel that are typically used in the oil and gas industry to facilitate the planned downhole conveyance operations for the planned tool string, the planned well, and the planned conveyance operational parameters. Thus, the engine 1100 may determine the baseline quantity of pollutant emission by calculating pollutant emission output data 1132 based on inputs 1120 (e.g., the input data listed on table 1200) indicative of conveyance equipment, conveyance operational parameters, surface equipment, corrective equipment, transportation equipment, and/or quantities of human personnel that are typically used in the oil and gas industry, but not based on one or more of the output data 732, 742, 1142, 1144, 1146, 1148 (e.g., the output data listed on table 1300) indicative of conveyance equipment, conveyance operational parameters, surface equipment, corrective equipment, transportation equipment, and/or quantities of human personnel determined by the engine 1100. In other words, the baseline quantity of pollutant emission may be calculated based on inputs 1120 that exclude one or more of the output data 732, 742, 1142, 1144, 1146, 1148 determined by the engine 1100. The baseline quantity of pollutant emission for the planned tool string, the planned well, and the planned conveyance operational may also or instead be manually input by a human user of the engine 1100. The conveyance equipment, conveyance operational parameters, surface equipment, corrective equipment, transportation equipment, and/or quantities of human personnel that are typically used in the oil and gas industry may be determined based on historical records and/or published data.

The determined pollutant emission output data 1132 may be displayed to the human user (e.g., human wellsite personnel) of the engine 1100 via a video output device. The human user may then implement the conveyance operations via the conveyance equipment indicated in the conveyance equipment output data 742, the operational parameters indicated in the conveyance operational output data 732, surface equipment indicated in the surface equipment output data 1142, corrective equipment indicated in the corrective equipment output data 1144, transportation equipment indicated in the transportation equipment output data 1146, and/or by using the human personnel indicated in the human personnel output data 1148.

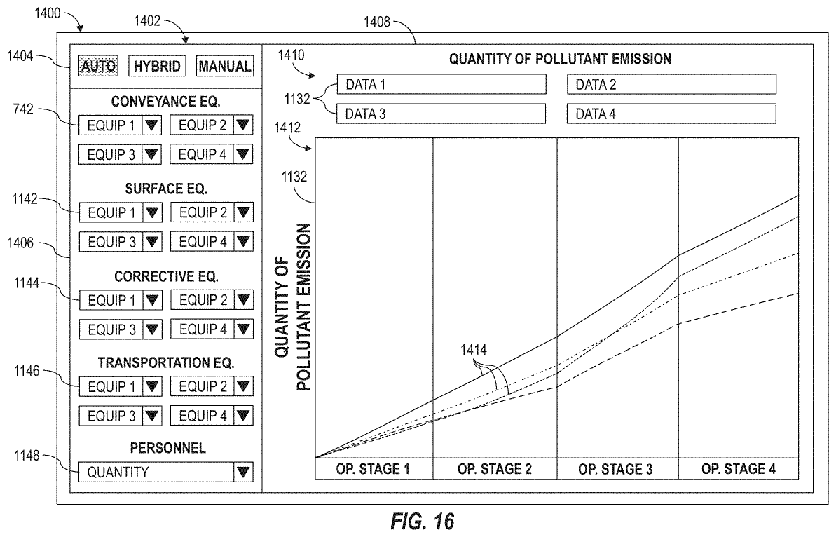

FIG. 16 is an example implementation of a display screen 1402 that may be displayed by a video output device (e.g., a display monitor, a touchscreen, etc.) of a human machine interface (HMI) 1400 for controlling the conveyance job analysis engine 1100 and viewing various outputs 1130, 1140 generated by the engine 1100. Accordingly, the following description refers to FIGS. 13 and 16, collectively.

The display screen 1402 may comprise a mode of operation confirmation area (or window) 1404, which may be used by a human user to set (or select) a mode of operation of the engine 1100 and to visually confirm in which mode of operation the engine 1100 is operating. For example, the engine 1100 may be operated in an automatic mode of operation, in which the engine 1100 automatically generates the intermediary outputs 1140 and the outputs 1130 after receiving the inputs 1120, as described above. The engine 1100 may instead be operated in a manual mode of operation, in which the engine 1100 is operable to receive intermediary outputs 1140 manually entered by the human user. The engine 1100 may then automatically generate the outputs 1130 after receiving the inputs 1120 and the intermediary outputs 1140. The intermediary outputs 1140 may be entered into the engine 1100 by the human user via the HMI 1400. The engine 1100 may instead be operated in a hybrid mode of operation, in which the engine 1100 automatically generates the intermediary outputs 1140 and the outputs 1130 after receiving the inputs 1120. However, one or more of the intermediary outputs 1140 may be manually entered by the human user, causing the engine 1100 to automatically update (or change) the outputs 1130 based on the manually entered intermediary outputs 1140.

The window 1404 may comprise a plurality of virtual (or software) buttons, each containing a description (e.g., text, icons, graphics, etc.) of a corresponding mode of operation of the engine 1100. One of the buttons may be operated (e.g., touched, clicked on, etc.) by the human user to cause the HMI 1400 to output (or transmit) a mode of operation setting (or signal) to the engine 1100 to set (or select) the mode of operation in which the engine 1100 is to operate. The button associated with the selected mode of operation of the engine 1100 may activate (e.g., light up, change color, etc.) to visually confirm or otherwise indicate to the human user the current mode of operation of the engine 1100.

The display screen 1402 may further comprise an intermediate output display area (or window) 1406 for displaying various intermediate outputs 1140, such as the conveyance equipment output data 742, the surface equipment output data 1142, the corrective equipment output data 1144, the transportation equipment output data 1146, and the human personnel output data 1148 generated by the engine 1100. While the engine 1100 is in the manual or hybrid modes of operation, the display area 1406 of the HMI 1400 may be used or otherwise operable to receive one or more of the intermediate outputs 1140 manually entered by the human user. For example, the human user may operate (or open) one or more drop-down menus associated with each intermediate output 1140 and select one or more intended pieces (or sets) of equipment and/or quantity of human personnel to perform or otherwise facilitate the planned conveyance operations. The HMI 1400 may then output (or transmit) the entered data to the engine 1100, such that the engine 1100 can generate or update the other outputs 1130, 1140.

The display screen 1402 may also comprise a pollutant emission display area (or window) 1408 for displaying the pollutant emission output data 1132. The display area 1408 may comprise a list area (or window) 1410 displaying the pollutant emission output data 1132 in textual and/or numerical form. The display area 1408 may comprise an illustrative area (or window) 1412 displaying the pollutant emission output data 1132 in graphic, descriptive, or otherwise illustrative form. Although the illustrative area 1412 is shown displaying the pollutant emission output data 1132 in form of a graph, the illustrative area 1412 may display the pollutant emission output data 1132 in form of tables, bars, gauges, lights, flow-charts, and/or schematics, among other examples.

If the engine 1100 generates conveyance equipment output data 742 indicative of a plurality of different alternative sets of conveyance equipment, each set being operable to perform the planned conveyance operations, the engine 1100 may determine the expected quantity of pollutant emission for each set of conveyance equipment, as described above. The expected quantity of pollutant emission for each set of conveyance equipment may be displayed in the list area 1410 in textual and/or numerical form and/or in the illustrative area 1412 in graphic form. For example, each curve (or trend line) 1414 in illustrative area 1412 may be indicative of an expected quantity of pollutant emission for a corresponding set of conveyance equipment (and other equipment) determined by the engine 1100 and listed in the display area 1406. One of the curves 1414 may be indicative of a baseline quantity of pollutant emission determined by the engine 1100, as described above. The graph displayed in the illustrative area 1412 may be divided into a plurality of operational stages, with each operational stage corresponding to an operational stage (or phase) of the conveyance operations. For example, operational stage 1 may correspond to transportation operations during which the conveyance equipment, the corrective equipment, the surface equipment, and/or the human personnel are transported to the wellsite. Operational stage 2 may correspond to conveyance operations during which the planned tool string is conveyed within the planned well. Operational stage 3 may correspond to corrective operations during which, for example, a stuck tool string is retrieved to the wellsite surface. Operational stage 4 may correspond to subsequent conveyance operations during which the planned tool string is conveyed within the planned well after the corrective operations are performed. Each curve 1414 may therefore be indicative of expected quantity of pollutant emission produced during each operational stage.

As described above, the engine 1100 may also or instead determine an expected reduced quantity of pollutant emission for each set of conveyance equipment. The engine 1100 may then compare the baseline quantity of pollutant emission and each expected reduced quantity of pollutant emission to determine the pollutant emission output data 1132 indicative of the expected reduction of the quantity of pollutant emission for each set of conveyance equipment. Each curve 1414 may therefore be indicative of an expected reduction of the quantity of pollutant emission produced during the operational stages of the conveyance operations.

The human user viewing the data shown on the display screen 1402 of the HMI 1400 may evaluate and select one of the sets of conveyance equipment based on predetermined factors (or considerations), which may include one or more of the reduction of the quantity of pollutant emission for each set of conveyance equipment, cost of implementing the conveyance operations via each set of conveyance equipment, and duration of time for completing the conveyance operations via each set of conveyance equipment. The human user may weigh (or balance) the factors based on predetermined goals. For example, the human user may select one of the sets of conveyance equipment associated with the lowest quantity (or largest decrease) of pollutant emission, regardless of other factors. The human user may instead select one of the sets of conveyance equipment associated with the lowest quantity (or largest decrease) of pollutant emission, when the associated cost and/or the duration of time for completing the conveyance operations are within acceptable thresholds. The human user may instead select one of the sets of conveyance equipment associated with the shortest duration of time for completing the conveyance operations, such as when completion time is vital for the planned conveyance operations. The human user may instead select one of the sets of conveyance equipment associated with the shortest duration of time for completing the conveyance operations, when the associated cost and/or quantity of pollutant emission are within acceptable thresholds. The human user may instead select one of the sets of conveyance equipment associated with the lowest cost for completing the conveyance operations, when the associated quantity of pollutant emission and/or the duration of time for completing the conveyance operations are within acceptable thresholds. The human user or other human personnel (e.g., wellsite personnel) may then implement the conveyance operations via the selected conveyance equipment indicated in the conveyance equipment output data 742, via the operational parameters indicated in the conveyance operational output data 732, via other equipment indicated in the output data 1142, 1144, 1146, and/or by using the human personnel indicated in the human personnel output data 1148.

The present disclosure is further directed to example methods (e.g., operations and/or processes) that can be performed to determine or otherwise facilitate determination of pollutant emission output data indicative of a quantity of pollutant emission related to the planned conveyance operations. The methods may be performed by utilizing (or otherwise in conjunction with) at least a portion of one or more implementations of one or more instances of the apparatus shown in one or more of FIGS. 1-16, and/or otherwise within the scope of the present disclosure. The methods may be caused to be performed, at least partially, by a processing system (e.g., the processing system 900, the engine 1100, etc.) executing computer program code according to one or more aspects of the present disclosure. Thus, the present disclosure is also directed to a non-transitory, computer-readable medium comprising computer program code that, when executed by the controller, may cause such controller to perform the example methods described herein. The methods may also or instead be caused to be performed, at least partially, by a human user (e.g., human wellsite personnel) utilizing one or more instances of the apparatus shown in one or more of FIGS. 1-16, and/or otherwise within the scope of the present disclosure. Thus, the following description of example methods refer to apparatus shown in one or more of FIGS. 1-16. However, the methods may also be performed in conjunction with implementations of apparatus other than those depicted in FIGS. 1-16 that are also within the scope of the present disclosure.

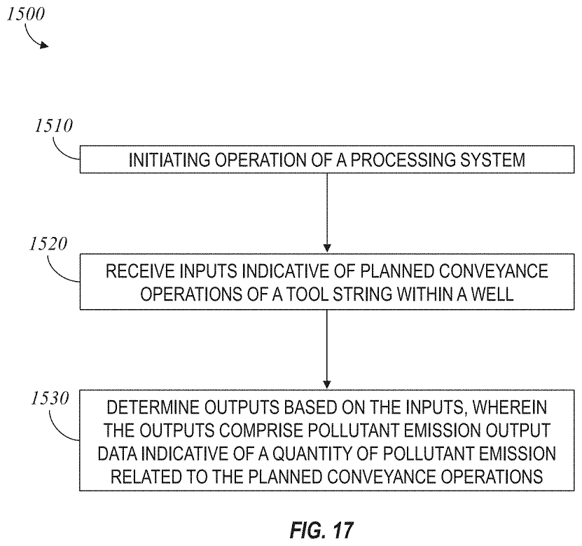

FIG. 17 is a flow-chart diagram of at least a portion of an example method (or operation) 1500 for determining pollutant emission output data indicative of a quantity of pollutant emission related to planned conveyance operations. The method 1500 may be performed in conjunction with at least a portion of one or more implementations of one or more instances of the apparatus shown in one or more of FIGS. 1-16. The method 1500 may be performed, at least partially, by a processing system (e.g., the processing system 900, the engine 1100, etc.) executing computer program code according to one or more aspects of the present disclosure. Accordingly, the following description refers to FIGS. 1-17, collectively.

The method 1500 may comprise initiating 1510 operation of the processing system, thereby causing the processing system to: receive 1520 inputs 1120 indicative of planned conveyance operations of a tool string within a well and determine 1530 outputs 1130, 1140 based on the inputs.

The inputs 1120 may comprise a tool string input data 724 indicative of the tool string that is planned to be conveyed within the well during the planned conveyance operations, planned conveyance operational input data 728 indicative of planned operational parameters at which the planned conveyance operations are planned to be performed, and/or well input data 726 indicative of the well within which the tool string is planned to be conveyed during the planned conveyance operations. The inputs 1120 may also or instead comprise conveyance equipment input data 722 indicative of conveyance equipment operable to perform the planned conveyance operations and/or pollutant emission input data 1122 indicative of a quantity of pollutant emission related to each instance of the conveyance equipment.

The outputs 1130 may comprise pollutant emission output data 1132 indicative of a quantity of pollutant emission related to the planned conveyance operations. The pollutant emission output data 1132 may be indicative of a quantity of pollutants that will be emitted while facilitating the planned conveyance operations. The pollutant emission output data 1132 may also or instead be indicative of a reduction of a quantity of pollutants that will be emitted while facilitating the planned conveyance operations.

The outputs 1140 may comprise conveyance equipment output data 742 indicative of first conveyance equipment operable to perform the planned conveyance operations and second conveyance equipment operable to perform the planned conveyance operations. Thus, the quantity of pollutant emission may be a first quantity of pollutant emission related to the planned conveyance operations while being performed by using the first conveyance equipment and the pollutant emission output data 1132 may be further indicative of a second quantity of pollutant emission related to the planned conveyance operations while being performed by using the second conveyance equipment. The outputs 1140 may also or instead comprise one or more of conveyance equipment output data 742 indicative of conveyance equipment to be used to perform the planned conveyance operations and/or conveyance operational output data 732 indicative of operational parameters at which the conveyance equipment is to be operated to perform the planned conveyance operations. The quantity of pollutant emission may be related to the planned conveyance operations while being performed by using the conveyance equipment and/or while being performed at the operational parameters.

The pollutant emission output data 1132 may be indicative of a difference between: a quantity of pollutants that will be emitted while performing the planned conveyance operations by using the conveyance equipment indicated in the conveyance equipment output data 742 and/or while performing the planned conveyance operations at the operational parameters indicated in the conveyance operational output data 732; and a quantity of pollutants that will be emitted while performing the planned conveyance operations by using conveyance equipment not indicated in the conveyance equipment output data 742 and/or while performing the planned conveyance operations at operational parameters not indicated in the conveyance operational output data 732. The pollutant emission output data 1132 may also or instead be indicative of a difference between: a quantity of pollutants that will be emitted while performing corrective operations resulting from the planned conveyance operations that have been performed by using the conveyance equipment indicated in the conveyance equipment output data 742 and/or while performing corrective operations resulting from the planned conveyance operations that have been performed at the operational parameters indicated in the conveyance operational output data 732; and a quantity of pollutants that will be emitted while performing corrective operations resulting from the planned conveyance operations that have been performed by using the conveyance equipment not indicated in the conveyance equipment output data 742 and/or while performing corrective operations resulting from the planned conveyance operations that have been performed at the operational parameters not indicated in the conveyance operational output data 732.

The pollutant emission output data 1132 may be determined by the conveyance model 710 or other portion of the engine 1100 based on one or more of the inputs 1120, the intermediary outputs 1140, and the conveyance operational output data 732. For example, the pollutant emission output data 1132 may be based on one or more of: a duration of time for performing the planned conveyance operations while being performed by using the conveyance equipment indicated in the conveyance equipment output data 742; a duration of time for performing the planned conveyance operations while being performed by using conveyance equipment not indicated in the conveyance equipment output data 742; a duration of time for performing the planned conveyance operations while being performed at the operational parameters indicated in the conveyance operational output data 732; a duration of time for performing the planned conveyance operations while being performed at operational parameters not indicated in the conveyance operational output data 732; a duration of time for performing downhole corrective operations resulting from the planned conveyance operations while being performed by using the conveyance equipment indicated in the conveyance equipment output data 742; a duration of time for performing downhole corrective operations resulting from the planned conveyance operations while being performed by using the conveyance equipment not indicated in the conveyance equipment output data 742; a duration of time for performing downhole corrective operations resulting from the planned conveyance operations while being performed at the operational parameters indicated in the conveyance operational output data 732; a duration of time for performing downhole corrective operations resulting from the planned conveyance operations while being performed at the operational parameters not indicated in the conveyance operational output data 732; a duration of time for transporting the conveyance equipment indicated in the conveyance equipment output data 742 to a wellsite at which the well is located; a duration of time for transporting the conveyance equipment not indicated in the conveyance equipment output data 742 to the wellsite at which the well is located; a duration of time for transporting the corrective equipment indicated in the conveyance equipment output data 742 to the wellsite at which the well is located; a duration of time for transporting corrective equipment not indicated in the conveyance equipment output data 742 to the wellsite at which the well is located; a quantity of wellsite personnel indicated in the human personnel output data 1148 used for operating the conveyance equipment indicated in the conveyance equipment output data 742; a quantity of wellsite personnel indicated in the human personnel input data 1128 used for operating the conveyance equipment not indicated in the conveyance equipment output data 742; a quantity of wellsite personnel indicated in the human personnel output data 1148 used for operating the corrective equipment indicated in the corrective equipment output data 1144; a rate of pollutant emission indicated in the pollutant emission input data 1122 of the conveyance equipment indicated in the conveyance equipment output data 742; a rate of pollutant emission indicated in the pollutant emission input data 1122 of the conveyance equipment not indicated in the conveyance equipment output data 742; a rate of pollutant emission indicated in the pollutant emission input data 1122 of the surface equipment indicated in the surface equipment output data 1142 at the wellsite at which the well is located; a rate of pollutant emission indicated in the pollutant emission input data 1122 of the transportation equipment indicated in the transportation equipment output data 1146 to transport the conveyance equipment indicated in the conveyance equipment output data 1144 to the wellsite at which the well is located; a rate of pollutant emission indicated in the pollutant emission input data 1122 of the transportation equipment indicated in the transportation equipment input data 1126 to transport the conveyance equipment not indicated in the conveyance equipment output data 742 to the wellsite at which the well is located; a rate of pollutant emission indicated in the pollutant emission input data 1122 of the transportation equipment indicated in the transportation equipment output data 1146 to transport the corrective equipment to the wellsite at which the well is located; and a rate of pollutant emission indicated in the pollutant emission input data 1122 of an instance of the wellsite personnel indicated in the human personnel input data 1128.

In view of the entirety of the present disclosure, including the figures and the claims, a person having ordinary skill in the art will readily recognize that the present disclosure introduces an apparatus comprising a processing system comprising a processor and a memory storing computer program code that, when executed by the processor, causes the processing system to predict outputs based on inputs, wherein: (A) the inputs comprise: (1) conveyance equipment input data indicative of conveyance equipment operable to perform conveyance operations of a tool string within a well; and (2) pollutant emission input data indicative of a quantity of pollutant emission related to the conveyance equipment; and (B) the outputs comprise pollutant emission output data indicative of a quantity of pollutant emission related to the conveyance operations.

The quantity of pollutant emission may be or comprise at least one of: a quantity of greenhouse gas (GHG) emission; a quantity of carbon emission; a quantity of carbon dioxide (CO₂) emission; a quantity of methane (CH₄) emission; a quantity of nitrous oxide (N₂O) emission; and a global warming potential of an emission.

The quantity of pollutant emission related to the conveyance operations may be or comprise a quantity of pollutant emission during the conveyance operations. The quantity of pollutant emission related to the conveyance operations may be or comprise a reduction of a quantity of pollutant emission during the conveyance operations.

The inputs may further comprise tool string input data indicative of characteristics of the tool string. The inputs may further comprise well input data indicative of characteristics of the well. The inputs may further comprise conveyance operational input data indicative of operational parameters at which the conveyance operations are to be performed.

The inputs further comprise surface equipment input data indicative of characteristics of surface equipment operable to perform the conveyance operations, and the outputs further comprise surface equipment output data indicative of a set of the surface equipment to perform the conveyance operations. The inputs may further comprise corrective equipment input data indicative of characteristics of corrective equipment operable to perform corrective operations to remedy problems that occurred during the performance of the conveyance operations, and the outputs may further comprise corrective equipment output data indicative of a set of the corrective equipment to perform the corrective operations. The inputs may further comprise transportation equipment input data indicative of characteristics of transportation equipment operable to perform transportation operations to transport equipment and human personnel to a wellsite at which the well is located, and the outputs may further comprise transportation equipment output data indicative of a set of the transportation equipment to perform the transportation operations.

The outputs may further comprise a conveyance equipment output data indicative of a first set of the conveyance equipment and a second set of the conveyance equipment, the quantity of pollutant emission may be a first quantity of pollutant emission related to the conveyance operations while being performed by the first set of the conveyance equipment, and the pollutant emission output data may be further indicative of a second quantity of pollutant emission related to the conveyance operations while being performed by the second set of the conveyance equipment.

The outputs may further comprise a conveyance equipment output data indicative of a set of the conveyance equipment to perform the conveyance operations, wherein the pollutant emission output data may be indicative of a difference between a quantity of pollutants that will be emitted while performing the conveyance operations by the set of the conveyance equipment indicated in the conveyance equipment output data and a quantity of pollutants that will be emitted while performing the conveyance operations by other set of the conveyance equipment not indicated in the conveyance equipment output data.

The outputs may further comprise a conveyance equipment output data indicative of a set of the conveyance equipment to perform the conveyance operations, wherein the pollutant emission output data may be indicative of the quantity of pollutant emission related to the conveyance operations performed by the set of the conveyance equipment. The inputs may further comprise tool string input data indicative of characteristics of the tool string. The inputs may further comprise well input data indicative of characteristics of the well. The inputs may further comprise conveyance operational input data indicative of operational parameters at which the conveyance operations are to be performed. The inputs may further comprise surface equipment input data indicative of characteristics of surface equipment operable to perform the conveyance operations, and the outputs may further comprise surface equipment output data indicative of a set of the surface equipment to perform the conveyance operations. The inputs may further comprise corrective equipment input data indicative of characteristics of corrective equipment operable to perform corrective operations to remedy problems that occurred during the performance of the conveyance operations, and the outputs may further comprise corrective equipment output data indicative of a set of the corrective equipment to perform the corrective operations. The inputs may further comprise transportation equipment input data indicative of characteristics of transportation equipment operable to perform transportation operations to transport equipment and human personnel to a wellsite at which the well is located, and the outputs may further comprise transportation equipment output data indicative of a set of the transportation equipment to perform the transportation operations. The inputs may further comprise human personnel input data indicative of a quantity of human personnel to perform the conveyance operations for each of the conveyance equipment operable to perform conveyance operations, and the outputs may further comprise human personnel output data indicative of a quantity of human personnel to perform the conveyance operations for the set of the conveyance equipment to perform the conveyance operations. The outputs may further comprise a conveyance operational output data indicative of operational parameters at which the set of the conveyance equipment is to be operated to perform the conveyance operations, wherein the pollutant emission output data may be indicative of the quantity of pollutant emission related to the conveyance operations while being performed at the operational parameters.

The present disclosure also introduces an apparatus comprising a processing system comprising a processor and a memory storing computer program code that, when executed by the processor, causes the processing system to predict outputs based on inputs, wherein: (A) the inputs comprise: (1) tool string input data indicative of characteristics of the tool string; (2) well input data indicative of characteristics of the well; (3) conveyance equipment input data indicative of conveyance equipment operable to perform conveyance operations of a tool string within a well; (4) conveyance operational input data indicative of operational parameters at which the conveyance operations are to be performed; and (5) pollutant emission input data indicative of a quantity of pollutant emission related to the conveyance equipment; and (B) the outputs comprise: (1) a conveyance equipment output data indicative of a set of the conveyance equipment to perform the conveyance operations; and (2) pollutant emission output data indicative of a quantity of pollutant emission related to the conveyance operations performed by the set of the conveyance equipment.

The quantity of pollutant emission may be or comprise at least one of: a quantity of greenhouse gas (GHG) emission; a quantity of carbon emission; a quantity of carbon dioxide (CO₂) emission; a quantity of methane (CH₄) emission; a quantity of nitrous oxide (N₂O) emission; and a global warming potential of an emission.

The quantity of pollutant emission related to the conveyance operations may be or comprise a quantity of pollutant emission during the conveyance operations. The quantity of pollutant emission related to the conveyance operations may be or comprise a reduction of a quantity of pollutant emission during the conveyance operations.

The inputs may further comprise surface equipment input data indicative of characteristics of surface equipment operable to perform the conveyance operations, and the outputs may further comprise surface equipment output data indicative of a set of the surface equipment to perform the conveyance operations. The inputs may further comprise corrective equipment input data indicative of characteristics of corrective equipment operable to perform corrective operations to remedy problems that occurred during the performance of the conveyance operations, and the outputs may further comprise corrective equipment output data indicative of a set of the corrective equipment to perform the corrective operations. The inputs may further comprise transportation equipment input data indicative of characteristics of transportation equipment operable to perform transportation operations to transport equipment and human personnel to a wellsite at which the well is located, and the outputs may further comprise transportation equipment output data indicative of a set of the transportation equipment to perform the transportation operations. The inputs may further comprise human personnel input data indicative of a quantity of human personnel to perform the conveyance operations for each of the conveyance equipment operable to perform conveyance operations, and the outputs may further comprise human personnel output data indicative of a quantity of human personnel to perform the conveyance operations for the set of the conveyance equipment to perform the conveyance operations.

The conveyance equipment output data may be indicative of a first set of the conveyance equipment and a second set of the conveyance equipment, the quantity of pollutant emission may be a first quantity of pollutant emission related to the conveyance operations while being performed by the first set of the conveyance equipment, and the pollutant emission output data may be further indicative of a second quantity of pollutant emission related to the conveyance operations while being performed by the second set of the conveyance equipment.

The conveyance equipment output data may be indicative of a set of the conveyance equipment to perform the conveyance operations, wherein the pollutant emission output data may be indicative of a difference between a quantity of pollutants that will be emitted while performing the conveyance operations by the set of the conveyance equipment indicated in the conveyance equipment output data and a quantity of pollutants that will be emitted while performing the conveyance operations by other set of the conveyance equipment not indicated in the conveyance equipment output data.

The outputs may further comprise a conveyance operational output data indicative of operational parameters at which the set of the conveyance equipment is to be operated to perform the conveyance operations, wherein the pollutant emission output data may be indicative of the quantity of pollutant emission related to the conveyance operations while being performed at the operational parameters.

The present disclosure also introduces a method comprising initiating operation of a processing system, thereby causing the processing system to: receive inputs indicative of planned conveyance operations of a tool string within a well; and determine outputs based on the inputs, wherein the outputs comprise pollutant emission output data indicative of a quantity of pollutant emission related to the planned conveyance operations.

The quantity of pollutant emission may be or comprise at least one of: a quantity of greenhouse gas (GHG) emission; a quantity of carbon emission; a quantity of carbon dioxide (CO₂) emission; a quantity of methane (CH₄) emission; a quantity of nitrous oxide (N₂O) emission; and a global warming potential of an emission.

The quantity of pollutant emission related to the conveyance operations may be or comprise a quantity of pollutant emission during the conveyance operations. The quantity of pollutant emission related to the conveyance operations may be or comprise a reduction of a quantity of pollutant emission during the conveyance operations.

The inputs may comprise conveyance equipment input data indicative of conveyance equipment operable to perform the planned conveyance operations and pollutant emission input data indicative of a quantity of pollutant emission related to the conveyance equipment, the outputs may further comprise a conveyance equipment output data indicative of a set of the conveyance equipment to perform the planned conveyance operations, and the pollutant emission output data may be indicative of the quantity of pollutant emission related to the planned conveyance operations performed by the set of the conveyance equipment.

The inputs may further comprise tool string input data indicative of characteristics of the tool string. The inputs may further comprise well input data indicative of characteristics of the well. The inputs may further comprise conveyance operational input data indicative of operational parameters at which the planned conveyance operations are to be performed.

The inputs may further comprise surface equipment input data indicative of characteristics of surface equipment operable to perform the planned conveyance operations, and the outputs may further comprise surface equipment output data indicative of a set of the surface equipment to perform the planned conveyance operations. The inputs may further comprise corrective equipment input data indicative of characteristics of corrective equipment operable to perform corrective operations to remedy problems that occurred during the performance of the planned conveyance operations, and the outputs may further comprise corrective equipment output data indicative of a set of the corrective equipment to perform the corrective operations. The inputs may further comprise transportation equipment input data indicative of characteristics of transportation equipment operable to perform transportation operations to transport equipment and human personnel to a wellsite at which the well is located, and the outputs may further comprise transportation equipment output data indicative of a set of the transportation equipment to perform the transportation operations. The inputs may further comprise human personnel input data indicative of a quantity of human personnel to perform the planned conveyance operations for each of the conveyance equipment operable to perform planned conveyance operations, and the outputs may further comprise human personnel output data indicative of a quantity of human personnel to perform the planned conveyance operations for the set of the conveyance equipment to perform the planned conveyance operations.

The outputs may further comprise a conveyance operational output data indicative of operational parameters at which the set of the conveyance equipment is to be operated to perform the planned conveyance operations, wherein the pollutant emission output data may b indicative of the quantity of pollutant emission related to the planned conveyance operations while being performed at the operational parameters.

The pollutant emission output data of the apparatuses and methods within the scope of the present disclosure may be based on one or more of: a duration of time for performing the conveyance operations while being performed by the conveyance equipment indicated in the conveyance equipment output data; a duration of time for performing the conveyance operations while being performed by other conveyance equipment not indicated in the conveyance equipment output data; a duration of time for performing the conveyance operations while being performed at the operational parameters indicated in the conveyance operational output data; a duration of time for performing the conveyance operations while being performed at other operational parameters not indicated in the conveyance operational output data; a duration of time for performing downhole corrective operations resulting from the conveyance operations while being performed by the conveyance equipment indicated in the conveyance equipment output data; a duration of time for performing downhole corrective operations resulting from the conveyance operations while being performed by the other conveyance equipment not indicated in the conveyance equipment output data; a duration of time for performing downhole corrective operations resulting from the conveyance operations while being performed at the operational parameters indicated in the conveyance operational output data; a duration of time for performing downhole corrective operations resulting from the conveyance operations while being performed at the other operational parameters not indicated in the conveyance operational output data; a duration of time for transporting the conveyance equipment indicated in the conveyance equipment output data to a wellsite at which the well is located; a duration of time for transporting the other conveyance equipment not indicated in the conveyance equipment output data to the wellsite at which the well is located; a duration of time for transporting the corrective equipment to the wellsite at which the well is located; a quantity of wellsite personnel for operating the conveyance equipment indicated in the conveyance equipment output data; a quantity of wellsite personnel for operating the other conveyance equipment not indicated in the conveyance equipment output data; a quantity of wellsite personnel for operating the corrective equipment; a rate of pollutant emission of the conveyance equipment indicated in the conveyance equipment output data; a rate of pollutant emission of the other conveyance equipment not indicated in the conveyance equipment output data; a rate of pollutant emission of surface equipment at the wellsite at which the well is located; a rate of pollutant emission of transportation equipment to transport one or more of the conveyance equipment indicated in the conveyance equipment output data, the other conveyance equipment not indicated in the conveyance equipment output data, the corrective equipment, and the surface equipment to the wellsite at which the well is located; and a rate of pollutant emission of an instance of the wellsite personnel.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the scope of the present disclosure.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

What is claimed is:

1. An apparatus comprising:
a processing system comprising a processor and a memory storing computer program code that, when executed by the processor, causes the processing system to predict outputs based on inputs, wherein:
the inputs comprise:
conveyance equipment input data indicative of conveyance equipment operable to perform conveyance operations of a tool string within a well; and
pollutant emission input data indicative of a quantity of pollutant emission related to the conveyance equipment; and
the outputs comprise pollutant emission output data indicative of a quantity of pollutant emission related to the conveyance operations.

2. The apparatus of claim 1 wherein the quantity of pollutant emission is or comprises at least one of:
a quantity of greenhouse gas (GHG) emission;
a quantity of carbon emission;
a quantity of carbon dioxide (CO₂) emission;
a quantity of methane (CH₄) emission;
a quantity of nitrous oxide (N₂O) emission; and
a global warming potential of an emission.

3. The apparatus of claim 1 wherein the quantity of pollutant emission related to the conveyance operations is or comprises a quantity of pollutant emission during the conveyance operations.

4. The apparatus of claim 1 wherein the quantity of pollutant emission related to the conveyance operations is or comprises a reduction of a quantity of pollutant emission during the conveyance operations.

5. The apparatus of claim 1 wherein the inputs further comprise tool string input data indicative of characteristics of the tool string.

6. The apparatus of claim 1 wherein the inputs further comprise well input data indicative of characteristics of the well.

7. The apparatus of claim 1 wherein the inputs further comprise conveyance operational input data indicative of operational parameters at which the conveyance operations are to be performed.

8. The apparatus of claim 1 wherein:
the inputs further comprise surface equipment input data indicative of characteristics of surface equipment operable to perform the conveyance operations; and
the outputs further comprise surface equipment output data indicative of a set of the surface equipment to perform the conveyance operations.

9. The apparatus of claim 1 wherein:
the inputs further comprise corrective equipment input data indicative of characteristics of corrective equipment operable to perform corrective operations to remedy problems that occurred during the performance of the conveyance operations; and
the outputs further comprise corrective equipment output data indicative of a set of the corrective equipment to perform the corrective operations.

10. The apparatus of claim 1 wherein:
the inputs further comprise transportation equipment input data indicative of characteristics of transportation equipment operable to perform transportation operations to transport equipment and human personnel to a wellsite at which the well is located; and
the outputs further comprise transportation equipment output data indicative of a set of the transportation equipment to perform the transportation operations.

11. The apparatus of claim 1 wherein:
the outputs further comprise a conveyance equipment output data indicative of:
a first set of the conveyance equipment; and
a second set of the conveyance equipment;
the quantity of pollutant emission is a first quantity of pollutant emission related to the conveyance operations while being performed by the first set of the conveyance equipment; and
the pollutant emission output data is further indicative of a second quantity of pollutant emission related to the conveyance operations while being performed by the second set of the conveyance equipment.

12. The apparatus of claim 1 wherein the outputs further comprise a conveyance equipment output data indicative of a set of the conveyance equipment to perform the conveyance operations, and wherein the pollutant emission output data is indicative of a difference between a quantity of pollutants that will be emitted while performing the conveyance operations by the set of the conveyance equipment indicated in the conveyance equipment output data and a quantity of pollutants that will be emitted while performing the conveyance operations by other set of the conveyance equipment not indicated in the conveyance equipment output data.

13. The apparatus of claim 1 wherein the outputs further comprise a conveyance equipment output data indicative of a set of the conveyance equipment to perform the conveyance operations, and wherein the pollutant emission output data is indicative of the quantity of pollutant emission related to the conveyance operations performed by the set of the conveyance equipment.

14. The apparatus of claim 13 wherein the inputs further comprise tool string input data indicative of characteristics of the tool string.

15. The apparatus of claim 13 wherein the inputs further comprise well input data indicative of characteristics of the well.

16. The apparatus of claim 13 wherein the inputs further comprise conveyance operational input data indicative of operational parameters at which the conveyance operations are to be performed.

17. The apparatus of claim 13 wherein:
the inputs further comprise surface equipment input data indicative of characteristics of surface equipment operable to perform the conveyance operations; and
the outputs further comprise surface equipment output data indicative of a set of the surface equipment to perform the conveyance operations.

18. The apparatus of claim 13 wherein:
the inputs further comprise corrective equipment input data indicative of characteristics of corrective equipment operable to perform corrective operations to remedy problems that occurred during the performance of the conveyance operations; and
the outputs further comprise corrective equipment output data indicative of a set of the corrective equipment to perform the corrective operations.

19. The apparatus of claim 13 wherein:
the inputs further comprise transportation equipment input data indicative of characteristics of transportation equipment operable to perform transportation operations to transport equipment and human personnel to a wellsite at which the well is located; and
the outputs further comprise transportation equipment output data indicative of a set of the transportation equipment to perform the transportation operations.

20. The apparatus of claim 13 wherein:
the inputs further comprise human personnel input data indicative of a quantity of human personnel to perform the conveyance operations for each of the conveyance equipment operable to perform conveyance operations; and
the outputs further comprise human personnel output data indicative of a quantity of human personnel to perform the conveyance operations for the set of the conveyance equipment to perform the conveyance operations.

21. The apparatus of claim 13 wherein the outputs further comprise a conveyance operational output data indicative of operational parameters at which the set of the conveyance equipment is to be operated to perform the conveyance operations, and wherein the pollutant emission output data is indicative of the quantity of pollutant emission related to the conveyance operations while being performed at the operational parameters.

22. The method of claim 21 wherein the pollutant emission output data is based on one or more of:
a duration of time for performing the conveyance operations while being performed by the conveyance equipment indicated in the conveyance equipment output data;
a duration of time for performing the conveyance operations while being performed by other conveyance equipment not indicated in the conveyance equipment output data;
a duration of time for performing the conveyance operations while being performed at the operational parameters indicated in the conveyance operational output data;
a duration of time for performing the conveyance operations while being performed at other operational parameters not indicated in the conveyance operational output data;
a duration of time for performing downhole corrective operations resulting from the conveyance operations while being performed by the conveyance equipment indicated in the conveyance equipment output data;
a duration of time for performing downhole corrective operations resulting from the conveyance operations while being performed by the other conveyance equipment not indicated in the conveyance equipment output data;
a duration of time for performing downhole corrective operations resulting from the conveyance operations while being performed at the operational parameters indicated in the conveyance operational output data;
a duration of time for performing downhole corrective operations resulting from the conveyance operations while being performed at the other operational parameters not indicated in the conveyance operational output data;
a duration of time for transporting the conveyance equipment indicated in the conveyance equipment output data to a wellsite at which the well is located;
a duration of time for transporting the other conveyance equipment not indicated in the conveyance equipment output data to the wellsite at which the well is located;
a duration of time for transporting the corrective equipment to the wellsite at which the well is located;
a quantity of wellsite personnel for operating the conveyance equipment indicated in the conveyance equipment output data;
a quantity of wellsite personnel for operating the other conveyance equipment not indicated in the conveyance equipment output data;
a quantity of wellsite personnel for operating the corrective equipment;
a rate of pollutant emission of the conveyance equipment indicated in the conveyance equipment output data;
a rate of pollutant emission of the other conveyance equipment not indicated in the conveyance equipment output data;
a rate of pollutant emission of surface equipment at the wellsite at which the well is located;
a rate of pollutant emission of transportation equipment to transport one or more of the conveyance equipment indicated in the conveyance equipment output data, the other conveyance equipment not indicated in the conveyance equipment output data, the corrective equipment, and the surface equipment to the wellsite at which the well is located; and
a rate of pollutant emission of an instance of the wellsite personnel.

23. An apparatus comprising:
a processing system comprising a processor and a memory storing computer program code that, when executed by the processor, causes the processing system to predict outputs based on inputs, wherein:
the inputs comprise:
tool string input data indicative of characteristics of the tool string;
well input data indicative of characteristics of the well;
conveyance equipment input data indicative of conveyance equipment operable to perform conveyance operations of a tool string within a well;
conveyance operational input data indicative of operational parameters at which the conveyance operations are to be performed; and
pollutant emission input data indicative of a quantity of pollutant emission related to the conveyance equipment; and
the outputs comprise:
a conveyance equipment output data indicative of a set of the conveyance equipment to perform the conveyance operations; and
pollutant emission output data indicative of a quantity of pollutant emission related to the conveyance operations performed by the set of the conveyance equipment.

24. A method comprising:
initiating operation of a processing system thereby causing the processing system to:
receive inputs indicative of planned conveyance operations of a tool string within a well; and
determine outputs based on the inputs, wherein the outputs comprise pollutant emission output data indicative of a quantity of pollutant emission related to the planned conveyance operations.

25. The method of claim 24 wherein:
the inputs comprise:
conveyance equipment input data indicative of conveyance equipment operable to perform the planned conveyance operations; and
pollutant emission input data indicative of a quantity of pollutant emission related to the conveyance equipment;
the outputs further comprise a conveyance equipment output data indicative of a set of the conveyance equipment to perform the planned conveyance operations; and
the pollutant emission output data is indicative of the quantity of pollutant emission related to the planned conveyance operations performed by the set of the conveyance equipment.

26. The apparatus of claim 25 wherein the outputs further comprise a conveyance operational output data indicative of operational parameters at which the set of the conveyance equipment is to be operated to perform the planned conveyance operations, and wherein the pollutant emission output data is indicative of the quantity of pollutant emission related to the planned conveyance operations while being performed at the operational parameters.
